(19) United States
(12) Patent Application Publication
(10) Pub. No.: US 2005/0157871 A1
(43) Pub. Date: Jul. 21, 2005

(54) Encryption/signature method, apparatus, and program

(76) Inventors: Yuichi Komano, Kawasaki-shi (JP); Shinichi Kawamura, Kodaira-shi (JP); Atsushi Shimbo, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/902,815

(22) Filed: Aug. 2, 2004

(30) Foreign Application Priority Data
Jan. 16, 2004 (JP) 2004-008840

(51) Int. Cl. H04L 9/00

(52) U.S. Cl. 380/28

(57) ABSTRACT

According to each embodiment of the present invention, random function operations less than three times and tight security can simultaneously be implemented. More specifically, a ciphertext y=c∥t or a signature σ=c′∥t is created as concatenated data of two data. The concatenated data is created by using a public key encryption scheme for only one (necessary part s) of the data. For this reason, tight security for the one-way characteristic of a trapdoor one-way function of the public key encryption scheme can be implemented. In addition, the output size of a first random function H′ is limited. Accordingly, a random function G for bit expansion in the conventional. OAEP++-ES scheme can be omitted. Hence, the number of times of use of random functions can be reduced to two.

### CROSS-REFERENCE TO RELATED APPLICATIONS

This application is based upon and claims the benefit of priority from prior Japanese Patent Application No. 2004-008840, filed Jan. 16, 2004, the entire contents of which are incorporated herein by reference.

### BACKGROUND OF THE INVENTION

1. Field of the Invention

The present invention relates to an encryption/signature method, apparatus, and program which use a public key encryption scheme and, more particularly, to an encryption/signature method, apparatus, and program which can simultaneously implement tight security and random function operations less than three times.

2. Description of the Related Art

Generally, encryption methods can be classified into secret key encryption schemes and public key encryption schemes. In a public key encryption scheme, key delivery that poses a problem in a secret key scheme can be avoided.

For example, in a public key encryption scheme, each of users A, B, . . . generates a set of a public key and a private key and registers the public key in a public directory. Each of the users A, B, . . . prepares only one set of keys independently of the total number of users. At the time of use, for example, the user A generates a ciphertext by using the public key of the user B in the public directory and transmits the ciphertext to the user B. The user B decrypts the received ciphertext by using his/her private key. As described above, in the public key encryption scheme, key delivery between the users A and B is unnecessary. Typical public key encryption schemes are RSA (Rivest-Shamir-Adleman) encryption, ElGamal encryption, and elliptic curve cryptography.

Such a public key encryption scheme uses a trapdoor one-way function represented by an RSA function. In a trapdoor one-way function, calculation in a certain direction can easily be executed, although calculation in the reverse direction is virtually impossible without private information.

In a public key encryption scheme, a ciphertext sender generates a ciphertext by calculation in a certain direction, and a ciphertext recipient decrypts the ciphertext by calculation in the reverse direction using private information. A third party does not have the private information. For this reason, the third party finds it virtually impossible to execute the calculation in the reverse direction even when he/she taps the ciphertext.

When the characteristic of a trapdoor one-way function is used in a direction reverse to that of an encryption scheme, a signature scheme can be implemented. In a signature scheme, only a signer having private information can generate a signature that can be verified by a third party. For example, each of the users A, B, . . . generates a set of a public key and a private key and registers the public key in a public directory. At the time of use, for example, the user A generates a signature from a document by using his/her private key and transmits the document and signature to the user B. The user B decrypts the signature by using the public key of the user A in the public directory and verifies the authenticity of the signature by comparing it with the document. Typical signature schemes are RSA signature, ElGamal signature, and DSA (Digital Signature Algorithm).

On the other hand, in the above-described public key encryption scheme and signature scheme, passive and active attack methods are present. In a passive attack method for a public key encryption scheme, the attacker searches for a plaintext from a ciphertext by using only public information. In an active attack method, the attacker adaptively chooses a ciphertext and causes an authentic recipient to decrypt it. Then, in an environment that allows reception of the decryption result, the attacker searches for a plaintext from the ciphertext and public information.

In a passive attack method for a signature scheme as well, the attacker outputs a signature for an arbitrary document by using only public information. In an active attack method, in an environment that allows an attacker to adaptively choose a document and cause an authentic signer to generate a signature for the document, the attacker outputs a signature for an arbitrary document by using the public information.

In both the public key encryption scheme and the signature scheme, the active attack method is stronger than the passive attack method. Building an encryption scheme or signature scheme safe even for the active attack method means that security of a higher level can be guaranteed.

As a public key encryption scheme resistant to active attack, OAEP (Optical Asymmetric Encryption Padding) has been proposed by Bellare and Rogaway on the basis of deterministic encryption such as RSA encryption. In OAEP, a plaintext to be encrypted is padded by using a random number. Then, a trapdoor one-way function such as RSA encryption is caused to act on the obtained padding data.

On the other hand, as a signature scheme resistant to active attack, PSS (Probabilistic Signature Scheme) has been proposed by the above-mentioned Bellare and Rogaway on the basis of deterministic signature such as on RSA signature. In PSS, a document to be signed is padded by using a random number. Then, a trapdoor one-way function such as on RSA signature is caused to act on the obtained padding data.

However, the OAEP and PSS use different padding data generation methods (to be referred to as padding schemes hereinafter). For this reason, when the encryption scheme (OAEP) and signature scheme (PSS) are implemented, two padding schemes are implemented, resulting in a large implementation size.

In addition, when the OAEP and PSS are implemented, a key set must be prepared for each scheme because it is doubtful whether the security can be guaranteed when the key set is shared by the two schemes. For this reason, the cost of key generation processing increases, and the key storage area also becomes large.

In order to solve these problems, Coron et al have proposed a PSS-ES scheme which can safely implement both the encryption scheme and the signature scheme by using a single padding scheme and key set (e.g., reference 1).

[Reference 1] J. S. Coron, M. Joye, D. Naccache, P. Paillier, “Universal Padding Scheme for RSA”, Advances in Cryptology—CRYPTO 2002, Springer-Verlag, 2002.

In the PSS-ES scheme, each user generates the same padding data s∥w in generating a ciphertext y and in generating a signature σ, as shown in FIG. 1A. To generate the ciphertext y, a public key pk of the recipient is used. To generate the signature σ, a user's private key sk is used. Referring to FIG. 1A, reference symbol r denotes a random number; and H′ and G, random functions. Reference symbol w denotes random data (w=H′(x∥r)) obtained by executing the random function H′ for concatenated data x∥r of a plaintext x and the random number r. A random function is a hash function such as SHA (Secure Hash Algorithm) or MD5 (Message Digest algorithm 5).

For the PSS-ES scheme, security has been proved for both the attack method for the encryption scheme and that for the signature scheme. The security of the encryption scheme and signature scheme is guaranteed by using the two random functions H′ and G and a single key set.

However, as is known, there is no tight security between the encryption scheme of the PSS-ES scheme and the calculative difficulty of an inverse function of a trapdoor one-way function. “Tight” means the degree of separation between the calculative difficulty in solving a problem and the calculative difficulty in solving another problem. For example, “tight” means that the difficulty in executing inverse function operation of a trapdoor one-way function and that in breaking an encryption scheme are almost the same.

Generally, to prove the security of an encryption scheme, the problem of breaking the encryption scheme results in the problem of breaking the one-way characteristic of a trapdoor one-way function. That is, when the problem of breaking the one-way characteristic of the trapdoor one-way function is difficult, security of the encryption scheme is proved. At this time, if it can be proved that the encryption scheme has tight security for the one-way characteristic of the trapdoor one-way function, the difficulty in breaking the encryption scheme is supposed to equal that in breaking the one-way characteristic of the trapdoor one-way function.

However, the PSS-ES scheme is known to have no tight security for the one-way characteristic of a trapdoor one-way function, as described above. More specifically, the PSS-ES scheme has tight security for the partial-domain one-way characteristic of a trapdoor one-way function.

Breaking the partial-domain one-way characteristic means obtaining partial information of the inverse function value of a given value for a trapdoor one-way function. That the partial-domain one-way characteristic is broken does not always mean that the trapdoor one-way function is broken. Conversely, when the one-way characteristic of a trapdoor one-way function is broken, the partial-domain one-way characteristic is broken. For this reason, breaking the partial-domain one-way characteristic of a function is easier than breaking the one-way characteristic.

More specifically, assuming a partial-domain one-way characteristic for a certain function means making a strong assumption that it is difficult to break even the partial-domain one-way characteristic which is relatively easy to break. In the PSS-ES scheme, since the partial-domain one-way characteristic is assumed, the evidence of security is weak. This is because if the partial-domain one-way characteristic which is relatively easy to break is broken, the PSS-ES scheme can be broken.

The PSS-ES scheme cannot guarantee tight security. To safely use this scheme, the size of the key pk must be large. For this reason, the PSS-ES scheme increases the calculation cost and key storage area.

As a scheme capable of guaranteeing tight security for the one-way characteristic of a trapdoor one-way function, on the basis of the OAEP scheme, OAEP++ scheme, and REACT scheme, Komano and Ohta have proposed an OAEP-ES scheme, OAEP++-ES scheme, and REACT-ES scheme (e.g., reference 2).

[Reference 2] Y. Komano, K Ohta, “Efficient Universal Padding Techniques for Multiplicative Trapdoor One-Way Permutation”, Advances in Cryptology—CRYPTO 2003, Springer-Verlag, 2003.

However, the OAEP-ES scheme, OAEP++-ES scheme, and REACT-ES scheme include three random operations of functions H′, G, and H, as shown in FIGS. 1B, 2A, and 2B. Hence, the implementation size is large.

More specifically, the OAEP-ES scheme has tighter security than the PSS-ES scheme. However, the tightness is smaller than the OAEP++-ES scheme and REACT-ES scheme. To safely use these schemes, the size of the key pk must be large. In addition, the OAEP-ES scheme includes three operations of the random functions H′, G, and H. For this reason, the implementation size is large.

The OAEP++-ES scheme has sufficiently tight security for the one-way characteristic of a trapdoor one-way function. However, to expand the output bit length of the first random function H′, the second random function G must be used. For this reason, the OAEP++-ES scheme requires the three random functions H′, G, and H. Hence, the implementation size is large.

The REACT-ES scheme has sufficiently tight security for the one-way characteristic of a trapdoor one-way function. However, since random encryption represented by the ElGamal encryption is used, the three random functions H′, G, and H must be used. In addition, since the REACT-ES scheme calculates the third random function H by using arithmetic results z1 and z1′ of a trapdoor one-way function which is time-consuming for execution, calculation process is slow.

As described above, of the conventional encryption/signature schemes, the schemes having tight security (OAEP-ES, OAEP++-ES, and REACT-ES) require three operations of random functions, and therefore, the implementation size becomes large. On the other hand, in the scheme (PSS-ES) which requires only two operations of random functions, the security is not tight.

### BRIEF SUMMARY OF THE INVENTION

It is an object of the present invention to provide an encryption/signature method, apparatus, and program which can simultaneously implement tight security and random function operations less than three times.

According to a first aspect of the present invention, there is provided an encryption/signature method used in an encryption/signature apparatus which can execute encryption processing and signature processing by a public key encryption scheme using a plurality of random functions, comprising inputting target data x of one of encryption processing and signature processing, generating a random number r to be concatenated to the target data x, concatenating the target data x and the random number r to obtain concatenated data x∥r, executing a first random function H′ for the concatenated data x∥r to calculate H′(x∥r)=w and generate first random data w having a size not less than that of the concatenated data x∥r, generating process target data s by calculating an exclusive OR between the concatenated data x∥r and the first random data w, executing a second random function H for the process target data s to generate second random data H(s) having the same size as that of the first random data w, generating padding data t by calculating an exclusive OR between the first random data w and the second random data H(s), executing one of encryption processing and signature processing for the process target data s by the public key encryption scheme, and concatenating the padding data t and one of encrypted data c and signed data c′ obtained by execution and outputting one of an obtained ciphertext c∥t and signature c′∥t.

According to a second aspect of the present invention, there is provided an encryption/signature method used in an encryption/signature apparatus which can execute encryption processing and signature processing by a deterministic public key encryption scheme using a plurality of random functions, comprising inputting target data x of one of encryption processing and signature processing, generating a random number r to be concatenated to the target data x, concatenating the target data x and the random number r to obtain concatenated data x∥r, executing a first random function H′ for the concatenated data x∥r to calculate H′(x∥r)=w and generate first random data w having a size not less than an input size of the public key encryption scheme, executing a second random function G for the first random data w to generate second random data G(w) having a size not less than a size of the concatenated data x∥r, generating padding data s by calculating an exclusive OR between the concatenated data x∥r and the second random data G(w), executing one of encryption processing and signature processing for the first random data w by the public key encryption scheme, and concatenating the padding data s and one of encrypted data c and signed data c′ obtained by execution and outputting one of an obtained ciphertext s∥c and signature s∥c′.

According to the first and second aspects of the present invention, unlike the conventional PSS-ES scheme (FIG. 1A) or OAEP-ES scheme (FIG. 1B), a ciphertext or signature is created as concatenated data obtained by concatenating two data, as shown in FIG. 3. In addition, the concatenated data is created by using the public key encryption scheme for only one (necessary part) of the data. Hence, tight security for the one-way characteristic of the trapdoor one-way function of the public key encryption scheme can be implemented.

According to the first aspect, the output size of the first random function H′ is equal to or larger than the size of the concatenated data x∥r. Accordingly, the random function G for bit expansion in the conventional OAEP++-ES scheme (FIG. 2A) can be omitted. For this reason, the number of times of use of random functions can be reduced to two.

On the other hand, according to the second aspect, the assumption for the trapdoor one-way function of the public key encryption scheme is limited to the deterministic encryption represented by RSA encryption so that the third random function H of the conventional REACT-ES scheme (FIG. 2B) can be omitted. For this reason, the number of times of use of random functions can be reduced to two.

Hence, according to the first and second aspects of the present invention, both tight security and random function operations less than three times can simultaneously be implemented.

### BRIEF DESCRIPTION OF THE SEVERAL VIEWS OF THE DRAWING

FIGS. 1A and 1B are schematic views for explaining the outline of conventional encryption/signature schemes;

FIGS. 2A and 2B are schematic views for explaining the outline of conventional encryption/signature schemes;

FIGS. 3A and 3B are schematic views for explaining the outline of encryption/signature schemes according to the embodiments of the present invention;

FIG. 4 is a schematic block diagram showing the arrangement of an encryption apparatus according to the first embodiment of the present invention;

FIG. 5 is a schematic block diagram showing the arrangement of a decryption apparatus according to the first embodiment;

FIGS. 6A and 6B are flowcharts for explaining operations according to the first embodiment;

FIG. 7 is a schematic view for explaining a modification to the first embodiment;

FIG. 8 is a schematic block diagram showing the arrangement of a signature apparatus according to the second embodiment of the present invention;

FIG. 9 is a schematic block diagram showing the arrangement of a signature verification apparatus according to the second embodiment;

FIGS. 10A and 10B are flowcharts for explaining operations according to the second embodiment;

FIG. 11 is a schematic block diagram showing the arrangement of an encryption/signature apparatus according to the third embodiment of the present invention;

FIG. 12 is a schematic block diagram showing the arrangement of an encryption apparatus according to the fourth embodiment of the present invention;

FIG. 13 is a schematic block diagram showing the arrangement of a decryption apparatus according to the fourth embodiment;

FIGS. 14A and 14B are flowcharts for explaining operations according to the fourth embodiment;

FIG. 15 is a schematic block diagram showing the arrangement of a signature apparatus according to the fifth embodiment of the present invention;

FIG. 16 is a schematic block diagram showing the arrangement of a signature verification apparatus according to the fifth embodiment;

FIGS. 17A and 17B are flowcharts for explaining operations according to the fifth embodiment; and

FIG. 18 is a schematic block diagram showing the arrangement of an encryption/signature apparatus according to the sixth embodiment of the present invention.

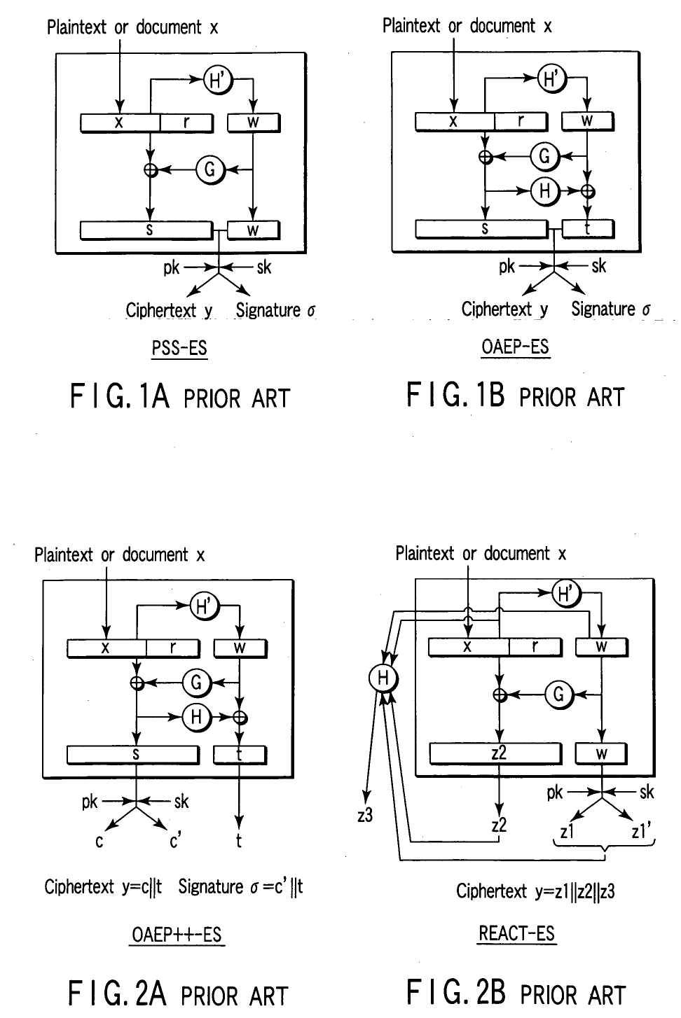

### DETAILED DESCRIPTION OF THE INVENTION

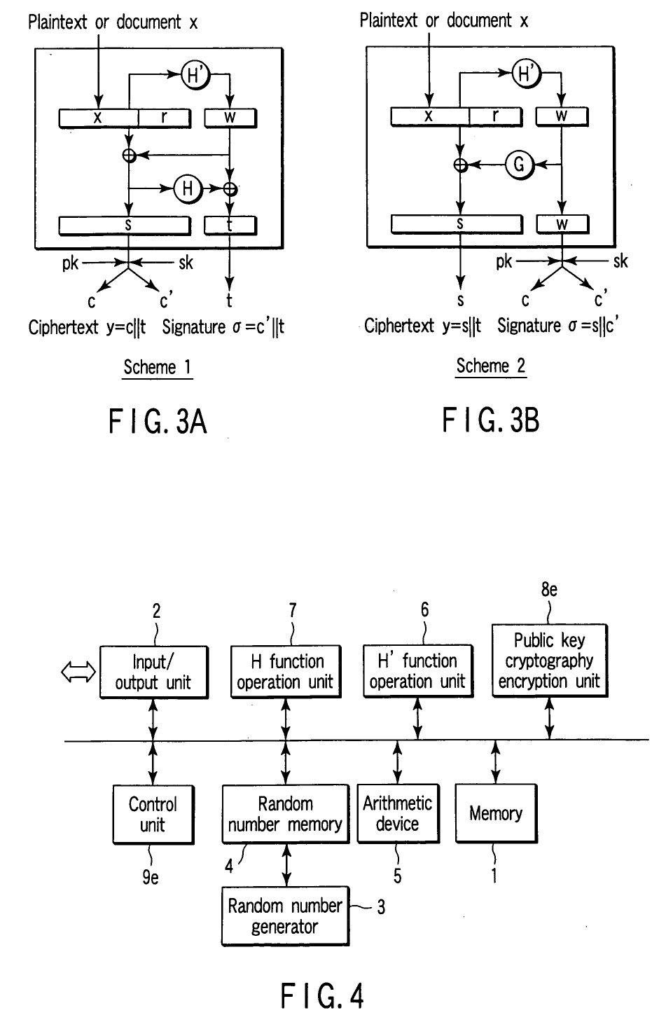

The embodiments of the present invention will be described below with reference to the accompanying drawing. First, the outline of the embodiments will be described. The embodiments are classified into scheme 1 shown in FIG. 3A corresponding to the above-described first invention and scheme 2 shown in FIG. 3B corresponding to the second invention.

More specifically, scheme 1 corresponds to the first to third embodiments. The first embodiment is related to encryption/decryption processing. The second embodiment is related to signature/verification processing. The third embodiment is a combination of the first and second embodiments.

Similarly, scheme 2 corresponds to the fourth to sixth embodiments. The fourth embodiment is related to encryption/decryption processing. The fifth embodiment is related to signature/verification processing. The sixth embodiment is a combination of the fourth and fifth embodiments.

In the embodiments, as a public key encryption scheme, deterministic encryption represented by RSA encryption (RSA signature) is used. Two random functions are hash functions such as SHA. The embodiments will be described below in detail.

### First Embodiment

FIG. 4 is a schematic block diagram showing the arrangement of an encryption apparatus according to the first embodiment of the present invention. FIG. 5 is a schematic block diagram showing the arrangement of a decryption apparatus according to the first embodiment. The same reference numerals denote the same elements in these views, and a detailed description thereof will be omitted. Different parts will mainly be described here. This also applies to the remaining embodiments.

The encryption apparatus comprises a memory 1, input/output unit 2, random number generator 3, random number memory 4, arithmetic device 5, H′ function operation unit 6, H function operation unit 7, public key cryptography encryption unit 8e, and control unit 9e. The elements 1, 2, and 4 to 9e except the random number generator 3 are connected through a bus. The suffix e in the units 8e and 9e represents encryption processing. A suffix d (to be described later) represents decryption processing.

The memory 1 is a storage unit which can be read from or written by the units 2 to 9e. The memory 1 stores data such as plaintext data x, public key pk, concatenated data x∥r, first random data w, process target data s, second random data H(s), padding data t, encrypted data c, and ciphertext c∥t.

The input/output unit 2 is an interface device between the encryption apparatus and an external device. The input/output unit 2 has, e.g., a function of inputting the plaintext data x and/or public key pk and writing them in the memory 1 and a function of outputting the ciphertext c∥t stored in the memory 1 as a result of encryption processing in accordance with a user operation.

The random number generator 3 generates a random number r necessary for generating a ciphertext or a signature. The random number generator 3 has a function of writing the generated random number r in the random number memory 4.

The random number memory 4 holds the random number r written from the random number generator 3 so that the random number r can be read from the arithmetic device 5.

The arithmetic device 5 executes multiple length operation for data in the memory 1 under the control of the units 6 to 9e. The arithmetic device 5 has, e.g., a function of executing exclusive OR calculation, bit concatenation/division, bit comparison, and the like, and a function of writing the execution result in the memory 1.

The H′ function operation unit 6 has a function of executing the first random function H′ for the concatenated data x∥r in the memory 1 to calculate H′(x∥r)=w and a function of writing the obtained first random data w in the memory 1.

In order to mask the concatenated data of a plaintext or document and a random number by using an output value, the first random function H′ must receive data having an arbitrary size (length) and output data having a size equal to or larger than that of the concatenated data of the plaintext and random number. The masking result is the input to a trapdoor one-way function f. Hence, to safely implement the encryption scheme, the output size of the first random function H′ must be equal to or larger than an input size k of the function f.

The H function operation unit 7 has a function of executing the second random function H for the process target data s in the memory 1 and a function of writing the obtained second random data H(s) in the memory 1. In order to mask the output value of the first random function H′ by using an output, the second random function H must receive data having an arbitrary size and output data having a size equal to or larger than the output size of the first random function H′. Hence, like the first random function H′, the output length of the second random function H must be equal to or larger than the input size k of the function f.

The public key cryptography encryption unit 8e has a function of executing encryption processing for the process target data s in the memory 1 on the basis of the public key pk in the memory 1 in accordance with the public key encryption scheme using the one-way function f, and a function of writing the obtained encrypted data c in the memory 1. The public key pk belongs to a ciphertext recipient who uses the decryption apparatus. The public key pk is read out from a public directory in advance. As the trapdoor one-way function f, a public key encryption scheme represented by RSA encryption scheme is used. When the length of the input/output value of the trapdoor one-way function f is represented by k, 1,024 or 2,048 (bits) is generally selected as k.

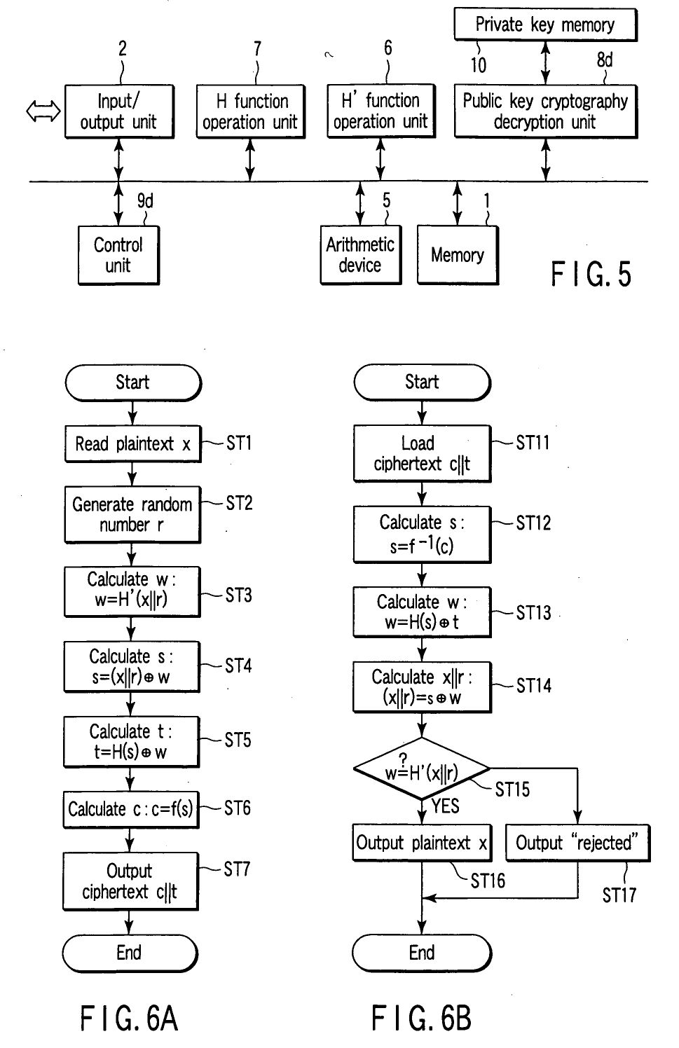

The control unit 9e controls the units 1 to 8e such that the received plaintext data x is encrypted on the basis of the plaintext data x and the public key pk of the public key encryption scheme, and the obtained ciphertext c∥t is output. More specifically, the control unit 9e has a function of controlling the units 1 to 8e as shown in FIG. 6A. The control unit 9e is implemented by installing, in advance, a program to implement the control function from a computer-readable storage medium to the computer of the apparatus through the input/output unit 2. This also applies to control units 9d to 9v and 12e to 12v (to be described later).

On the other hand, in the decryption apparatus, of the elements 1 to 9e of the encryption apparatus, the random number generator 3 and random number memory 4 are omitted. The decryption apparatus has a public key cryptography decryption unit 8d in place of the public key cryptography encryption unit 8e, and a control unit 9d for decryption processing in place of the control unit 9e for encryption processing. Accordingly, the decryption apparatus has a private key memory 10 which can be read by the public key cryptography decryption unit 8d. The remaining elements 1, 2, 6, and 7 of the decryption apparatus have the same processing functions as those of the elements 1, 2, 6, and 7 described for the encryption apparatus, though the contents of input/output data are different from those in the encryption apparatus.

The public key cryptography decryption unit 8d has a function of decrypting the encrypted data c in the memory 1 on the basis of a private key sk in the private key memory 10 in accordance with the public key encryption scheme and writing the obtained process target data s in the memory 1.

The control unit 9d controls the units 1 to 8e such that when the ciphertext c∥t obtained by the encryption apparatus is input, the ciphertext c∥t is decrypted on the basis of the ciphertext c∥t and the private key sk of the public key encryption scheme, and the obtained plaintext data x is output. More specifically, the control unit 9d has a function of controlling the units 1 to 8d as shown in FIG. 6B.

The private key memory 10 stores the private key sk related to the public key encryption scheme of the ciphertext recipient (decryption apparatus user). The private key memory 10 can be read-accessed from the public key cryptography decryption unit 8d.

The operations of the encryption and decryption apparatuses having the above arrangements will be described next with reference to the flowcharts shown in FIGS. 6A and 6B.

(Encryption Processing)

A ciphertext sender uses the encryption apparatus to encrypt a plaintext and transmit ciphertext to a ciphertext recipient. In this encryption apparatus, the units 1 to 8e are operated by the control unit 9e as shown in FIG. 6A.

First, the input/output unit 2 loads the plaintext data x to be encrypted and stores it in the memory 1 in accordance with the user operation (ST1).

The random number generator 3 generates the random number r to be concatenated to the plaintext data x and writes the random number r to the random number memory 4 (ST2).

The arithmetic device 5 concatenates the plaintext data x in the memory 1 and the random number r in the random number memory 4 and writes the obtained concatenated data x∥r to the memory 1.

The H′ function operation unit 6 executes the first random function H′ for the concatenated data x∥r in the memory 1 to calculate H′(x∥r)=w and writes the obtained first random data w to the memory 1 (ST3). The size of the first random data w is equal to or larger than that of the concatenated data x∥r.

The arithmetic device 5 calculates the exclusive OR between the concatenated data x∥r and the first random data w in the memory 1 and writes the obtained process target data s to the memory 1 (ST4).

The H function operation unit 7 executes the second random function H for the process target data s in the memory 1 and writes the obtained second random data H(s) to the memory 1. The size of the second random data H(s) is equal to that of the first random data w.

The arithmetic device 5 calculates the exclusive OR between the first random data w and the second random data H(s) in the memory 1 and writes the obtained padding data t to the memory 1 (ST5).

The public key cryptography encryption unit 8e executes encryption processing for the process target data s in the memory 1 on the basis of the public key pk in the memory 1 in accordance with the public key encryption scheme using the one-way function f and writes the obtained encrypted data c in the memory 1 (ST6). The public key pk belongs to a ciphertext recipient who uses the decryption apparatus.

The arithmetic device 5 concatenates the encrypted data c and padding data t in the memory 1 and writes the obtained ciphertext c∥t to the memory 1.

The input/output unit 2 outputs and displays a message representing that creation of the ciphertext c∥t is ended. The input/output unit 2 outputs and transmits the ciphertext c∥t in the memory 1 to the ciphertext recipient (decryption apparatus) in accordance with the user operation (ST7).

(Decryption Processing)

The ciphertext recipient uses the decryption apparatus to decrypt a ciphertext to obtain a plaintext. In this decryption apparatus, the units 1 to 8d are operated by the control unit 9d as shown in FIG. 6B.

The input/output unit 2 loads the ciphertext c∥t transmitted from the ciphertext sender and stores the ciphertext in the memory 1 (ST11).

The arithmetic device 5 separates the ciphertext c∥t in the memory 1 into the encrypted data c and padding data t and writes them to the memory 1.

The public key cryptography decryption unit 8d decrypts the encrypted data c in the memory 1 on the basis of the private key sk in the private key memory 10 in accordance with the public key encryption scheme and writes the obtained process target data s to the memory 1 (ST12).

The H function operation unit 7 executes the second random function H for the process target data s in the memory 1 and writes the obtained second random data H(s) to the memory 1.

The arithmetic device 5 calculates the exclusive OR between the second random data H(s) and padding data t in the memory 1 and writes the obtained first first random data w to the memory 1 (ST13).

The arithmetic device 5 calculates the exclusive OR between the first random data w and process target data s in the memory 1 and writes the obtained concatenated data x∥r to the memory 1 (ST14).

The H′ function operation unit 6 executes the first random function H′ for the concatenated data x∥r in the memory 1 to calculate H′(x∥r)=w′ and writes obtained second first random data w′ to the memory 1.

The control unit 9d determines whether the first and second first random data w and w′ in the memory 1 coincide with each other (ST15).

If YES in step ST15, the control unit 9d causes the arithmetic device 5 to separate the concatenated data x∥r and write the obtained plaintext data x and random number r to the memory 1.

The input/output unit 2 outputs the plaintext data x in the memory 1 (ST16).

If NO in step ST15, the control unit 9d rejects the ciphertext c∥t and causes the input/output unit 2 to output and display a message representing that “the ciphertext is rejected” (ST17). The processing is ended.

(Roles of Random Number r and Random Functions H′ and H)

The roles of the random number r, first random function H′, and second random function H in the above-described operations will be described next.

The random number r is used to generate a ciphertext at random. When the random number r is not used, a ciphertext is calculated deterministically for a plaintext.

“A ciphertext is generated at random for a plaintext” means that “for a plaintext, there exist a plurality of ciphertexts depending on a random number”. “A ciphertext is generated deterministically” means that “only one ciphertext exists for a plaintext”.

In a deterministic encryption scheme, if there is a plaintext candidate for a ciphertext to be attacked, an attacker can break indistinguishability, which is used as the security of the encryption scheme, by encrypting the plaintext candidate and determining, as a decrypted text, data that coincides with the ciphertext to be attacked. With the indistinguishability, even when an attacker issues ciphertext creation requests for two adaptively chosen plaintexts and receives a ciphertext generated from one plaintext, he/she cannot distinguish the plaintexts from which the ciphertext is generated.

That is, the deterministic encryption scheme is not safe because the indistinguishability can be broken, as described above.

However, when a ciphertext is generated by using the random number r, the attacker cannot break the indistinguishability because he/she cannot know the random number r which is selected to create the ciphertext to be attacked after issue of a ciphertext creation request.

To prevent an attacker from estimating the random number r, it must have such a size as to make it difficult in terms of complexity to search the random number by an exhaustive search. Generally, a value of 80 to 160 bits suffices.

The first random function H′ is used to guarantee the authenticity of a decrypted text obtained by decryption. In decryption, if the two data w and H′(x∥r) equal each other, it is determined that the obtained decrypted text x is authentic. If the two data are different, it is determined that the decrypted ciphertext is altered data. This also applies to signature verification (to be described later).

The second random function H is used to mask the data w to guarantee the security of the encryption scheme. The data w is a component that masks the concatenated data x∥r. If information about the data w is known, information about the plaintext can be obtained by unmasking the data w. In this embodiment, when the public key encryption scheme is safe, i.e., the trapdoor one-way function has a one-way characteristic, an attacker other than the authentic decrypter cannot obtain the input s from the ciphertext c∥t to the second random function H. For this reason, the attacker cannot unmask the data w. It is difficult to obtain the information about the plaintext.

(Reason for Security of Encryption Scheme)

The intuitive reason why the encryption processing of this embodiment is safe if the encryption function satisfies the one-way characteristic can be explained as follows. That an encryption scheme is safe intuitively means that any attacker cannot obtain even 1-bit information of a plaintext from a ciphertext. If an attacker who has received the ciphertext c∥t wants to obtain information about a corresponding plaintext, he/she must obtain the inverse function value s=f⁻¹(c) of c.

The reason why the encryption is safe will be described. If the attacker cannot reconstruct s, the value H(s) cannot be specified because of the characteristic of the second random function H. At this time, the probability of success of estimation for bits 0 and 1 of H(s) by the attacker is only 1/2. Hence, the attacker cannot specify the data w calculated from the exclusive OR of the data t and H(s). For this reason, the attacker cannot obtain even 1-bit information about the plaintext calculated from the exclusive OR of the data s and w.

More specifically, it is difficult to obtain information about a plaintext without obtaining the inverse function value s=f⁻¹(c). To break the encryption scheme, s=f⁻¹(c) must be obtained by breaking the one-way characteristic of the trapdoor one-way function.

(Security Against Active Attack)

Consider an attacker who attempts active attack for encryption processing according to this embodiment. The attacker sends a ciphertext decryption request to the authentic decrypter, receives a corresponding plaintext or a reply indicating that the ciphertext is illicit, and performs attack on the basis of information obtained at that time.

However, the attacker cannot obtain information about the plaintext. More specifically, the attacker can receive a corresponding plaintext only when a ciphertext generated by himself/herself in accordance with the encryption procedures is output as a decryption request text. Inversely, when the attacker sends, as a decryption request text, data generated without complying with the encryption procedures, he/she can only obtain a reply indicating that the decryption request text is an illicit ciphertext. The reason for this can be explained in the following way.

The decryption apparatus rejects the ciphertext c∥t as an illicit ciphertext if H′(x∥r)=w does not hold at the time of decryption.

Assume that c_{O}∥t_{O} is a decryption request text output from the attacker. Let s_{O} and w_{O} be data calculated from the decryption request text c_{O}∥t_{O} in accordance with the decryption procedures, x_{O} be a plaintext, and r_{O} be a random number. The data w_{O} is a value obtained by the exclusive OR between t_{O} and H(s_{O}) obtained by inputting the data s_{O} to the second random function H.

At this time, if the attacker outputs the decryption request text c_{O}∥t_{O} in accordance with encryption procedures, the attacker should have calculated a random function value H′(x_{O}∥r_{O}) by inputting a decryption request text x_{O}∥r_{O} to the first random function H′ and also calculated the random function value H(s_{O}) by inputting the data s_{O} to the second random function H by himself/herself.

Outputting the decryption request text without complying with the encryption procedures means that the random function value H(s_{O}) or H′(x_{O}∥r_{O}) is not calculated.

First, assume a case in which the attacker outputs the decryption request text c_{O}∥t_{O} without calculating the random function value H(s_{O}). Because of the characteristic of the second random function H, H(s_{O}) is a random value. The value w_{O} calculated by the exclusive OR between H(s_{O}) and the decryption request text t_{O} is a random value, too. Hence, independently of whether the attacker has obtained the random function value H′(x_{O}∥r_{O}), in general, x_{O}∥r_{O} calculated by the exclusive OR of the data w_{O} and s_{O} does not satisfy H′(x_{O}∥r_{O})=w_{O} because the data w_{O} has a random value. For this reason, the attacker can only obtain a reply indicating that the decryption request text is an illicit ciphertext.

Next, assume a case in which the attacker generates the decryption request text c_{O}∥t_{O} but not by obtaining the random function value H′(x_{O}∥r_{O}) by obtaining the random function value H(s_{O}). Because of the characteristic of the first random function H′, generally, H′(x_{O}∥r_{O})=w_{O} does not hold. For this reason, the attacker can only obtain a reply indicating that the decryption request text is an illicit ciphertext.

Since it is difficult for the attacker to obtain information even by active attack, the security of encryption processing can be proved.

As described above, according to this embodiment, the ciphertext c∥t is created as concatenated data obtained by concatenating the two data c and t, and the concatenated data is created by using the public key encryption scheme for only one (necessary part s) of the data, unlike the conventional PSS-ES scheme or OAEP-ES scheme. For this reason, tight security for the one-way characteristic of the trapdoor one-way function of the public key encryption scheme can be implemented. In addition, it can be proved that tight security for the one-way characteristic of the trapdoor one-way function of the public key encryption scheme can be ensured, and a predetermined security level can be guaranteed by a key with a smaller size. Hence, the storage area where the key is recorded can be reduced, and the calculation cost can also be reduced.

In this embodiment, the output size of the first random function H′ is equal to or larger than the size of the concatenated data x∥r. Accordingly, the random function G for bit expansion in the conventional OAEP++-ES scheme can be omitted. For this reason, the number of times of use of random functions can be reduced to two.

Hence, in this embodiment, both tight security and random function operation less than three times can simultaneously be implemented.

In the first embodiment, the output size of the second random function H can be larger than that of the first random function H′. In this case, when the exclusive OR between the output w of the first random function H′ and the output H(s) of the second random function H is to be calculated, a uniform bit length can be obtained by adding stationary bits to the output of the first random function or deleting the unnecessary portion of the output of the second random function.

In this embodiment, identical functions can be used as the first random function H′ and second random function H so that the number of random function operation units 6 and 7 can be reduced to only one. In this case, the present invention is different from the prior art in that an encryption/signature method having tight security can be implemented by executing random function operation only twice.

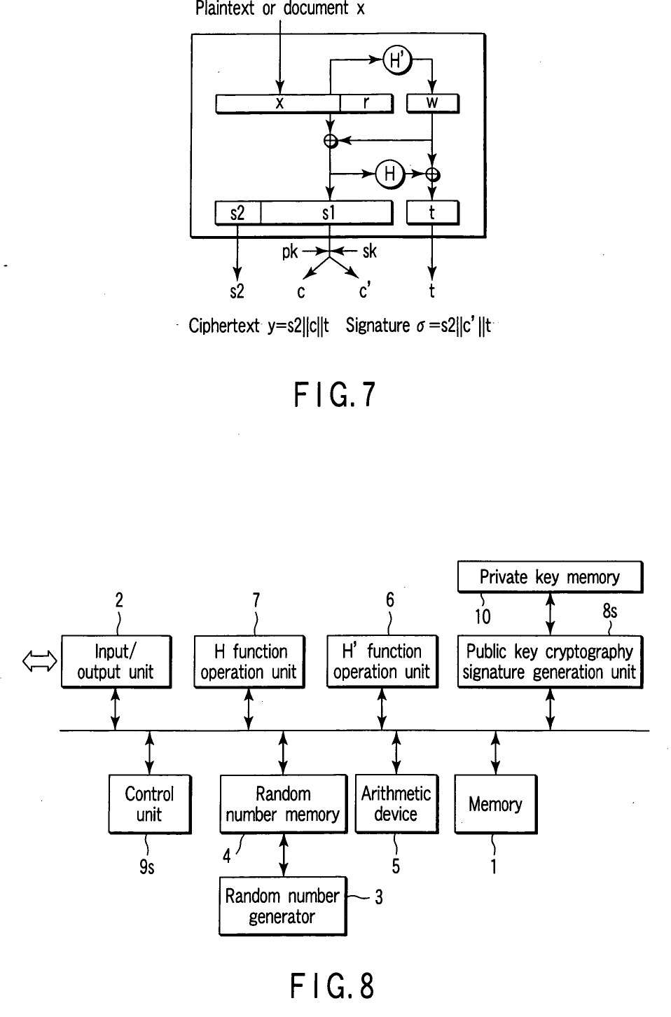

In this embodiment, as shown in FIG. 7, the size of the data s(=s1∥s2) can be made larger than the size k of the key used in the public key encryption system. In this case, only the partial information s1 of s, which has a length equal to the size k of the key used in the public key encryption system, is encrypted. The remaining part s2 of s is attached together with the encryption result. At this time, the unencrypted part s2 of s is information masked by the output of the first random function.

To unmask the data, it is necessary to execute inverse function operation of the trapdoor one-way function to totally reconstruct s and input s to the second random function to decrypt the data w. Then, the exclusive OR of the data w and s must be calculated. It can be proved in the same way as described above that the encryption scheme or signature scheme cannot be broken without breaking the one-way characteristic of the trapdoor one-way function. For this reason, even the method of encrypting only the partial information s1 of s shown in FIG. 7 and attaching the remaining unencrypted partial information s2 can be supposed to have tight security depending on the one-way characteristic of the trapdoor one-way function.

### Second Embodiment

FIG. 8 is a schematic block diagram showing the arrangement of a signature apparatus according to the second embodiment of the present invention. FIG. 9 is a schematic block diagram showing the arrangement of a signature verification apparatus according to the second embodiment.

This embodiment is a modification to the first embodiment. In the second embodiment, signature processing and signature verification processing using a private key sk are executed in place of encryption processing and decryption processing using the public key pk.

The signature apparatus has a public key cryptography signature generation unit 8s in place of the public key cryptography encryption unit 8e of the elements 1 to 9e of the encryption apparatus. The signature apparatus also has a control unit 9s for signature processing in place of the control unit 9e for encryption processing. Accordingly, the signature apparatus has a private key memory 10 which can be read-accessed from the public key cryptography signature generation unit 8s.

The suffix s represents signature processing. A suffix v (to be described later) represents signature verification processing. The remaining elements 1 to 7 of the signature apparatus have the same processing functions as those of the elements 1 to 7 described for the encryption apparatus, though the contents of input/output data are different from those in the encryption apparatus.

The public key cryptography signature generation unit 8s has a function of signing process target data s in the memory 1 on the basis of the private key sk in the private key memory 10 in accordance with the public key encryption scheme and a function of writing obtained signed data c′ in the memory 1.

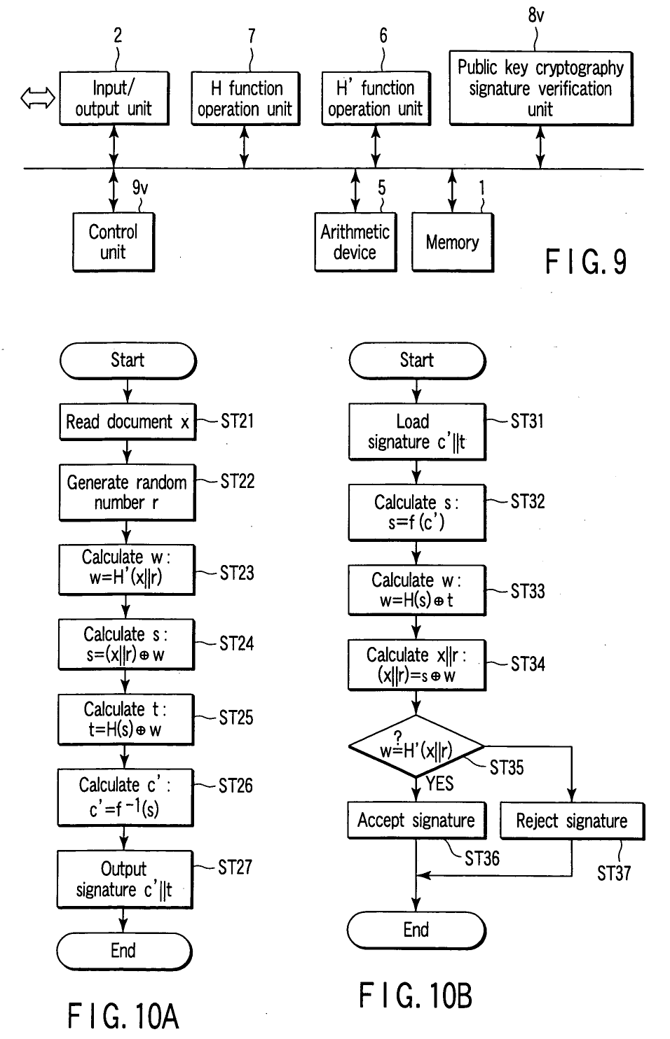

The control unit 9s controls the units 1 to 8s such that received document data x is signed on the basis of the document data x and the private key sk of the public key encryption scheme, and obtained signature c′∥t is output. More specifically, the control unit 9s has a function of controlling the units 1 to 8s as shown in FIG. 10A.

The private key memory 10 stores the private key sk related to the public key encryption scheme of the signature generator (signature apparatus user). The private key memory 10 can be read from the public key cryptography signature generation unit 8s.

On the other hand, in the signature verification apparatus, of the elements 1 to 9e of the encryption apparatus, the random number generator 3 and random number memory 4 are omitted. The signature verification apparatus has a public key cryptography signature verification unit 8v in place of the public key cryptography encryption unit 8e, and a control unit 9v for signature verification processing in place of the control unit 9e for encryption processing.

The remaining elements 1, 2, 6, and 7 of the signature verification apparatus have the same processing functions as those of the elements 1, 2, 6, and 7 described for the encryption apparatus, though the contents of input/output data are different from those in the encryption apparatus.

The signature verification unit 8v has a decryption function of reconstructing the signed data c′ in the memory 1 on the basis of a public key pk and writing the obtained process target data s in the memory 1, a determination function of determining whether first and second random data w and w′ in the memory 1 coincide with each other, and a signature accepting function of accepting the signature c′∥t as an authentic signature when the data w and w′ coincide with each other. The determination function and signature accepting function may be executed not by the signature verification unit 8v but by the control unit 9v.

The control unit 9v controls the units 1 to 8v such that when the signature c′∥t obtained by the signature apparatus is input, the authenticity of the signature c′∥t is verified on the basis of the signature c′∥t and the public key pk of the public key encryption scheme. More specifically, the control unit 9v has a function of controlling the units 1 to 8v as shown in FIG. 10B.

The operations of the signature and signature verification apparatuses having the above arrangements will be described next with reference to the flowcharts shown in FIGS. 10A and 10B.

(Signature Processing)

A signature generator uses the signature apparatus to transmit a signature obtained by signing a document to a signature verifier. In this signature apparatus, the units 1 to 8s are operated by the control unit 9s as shown in FIG. 10A.

First, the input/output unit 2 loads the document data x to be signed and stores it in the memory 1 in accordance with the user operation (ST21).

The random number generator 3 generate the random number r to be concatenated to the document data x and writes the random number r to the random number memory 4 (ST22).

The arithmetic device 5 concatenates the document data x in the memory 1 and the random number r in the random number memory 4 and writes the obtained concatenated data x∥r to the memory 1.

The H′ function operation unit 6 executes a first random function H′ for the concatenated data x∥r in the memory 1 to calculate H′(x∥r)=w and writes the obtained first random data w to the memory 1 (ST23). The size of the first random data w is equal to or larger than that of the concatenated data x∥r.

The arithmetic device 5 calculates the exclusive OR between the concatenated data x∥r and the first random data w in the memory 1 and writes the obtained process target data s to the memory 1 (ST24).

The H function operation unit 7 executes a second random function H for the process target data s in the memory 1 and writes the obtained second random data H(s) to the memory 1. The size of the second random data H(s) is equal to that of the first random data w.

The arithmetic device 5 calculates the exclusive OR between the first random data w and the second random data H(s) in the memory 1 and writes obtained padding data t to the memory 1 (ST25).

The public key cryptography signature generation unit 8s executes signature processing for the process target data s in the memory 1 on the basis of the private key sk in the private key memory 10 in accordance with the public key encryption scheme using a one-way function f and writes the obtained signed data c′ to the memory 1 (ST26). The private key sk belongs to a signature generator who uses the signature apparatus.

The arithmetic device 5 concatenates the signed data c′ and padding data t in the memory 1 and writes the obtained signature c′∥t to the memory 1.

The input/output unit 2 outputs and displays a message representing that creation of the signature c′∥t is ended. The input/output unit 2 outputs and transmits the document data x and signature c′∥t in the memory 1 to the signature verifier (signature verification apparatus) (ST27).

(Signature Verification Processing)

The signature verifier uses the signature verification apparatus to verify the authenticity of a signature. In this signature verification apparatus, the units 1 to 8v are operated by the control unit 9v as shown in FIG. 10B.

The input/output unit 2 loads the document data x and signature c′∥t transmitted from the signature generator and stores them in the memory 1 (ST31).

The arithmetic device 5 separates the signature c′∥t in the memory 1 into the signed data c′ and padding data t and writes them to the memory 1.

The public key cryptography signature verification unit 8v decrypts the signed data c′ in the memory 1 on the basis of the public key pk in accordance with the public key encryption scheme and writes the obtained process target data s to the memory 1 (ST32). The public key pk belongs to the signature generator.

The H function operation unit 7 executes the second random function H for the process target data s in the memory 1 and writes the obtained second random data H(s) to the memory 1.

The arithmetic device 5 calculates the exclusive OR between the second random data H(s) and padding data t in the memory 1 and writes the obtained first first random data w to the memory 1 (ST33).

The arithmetic device 5 calculates the exclusive OR between the first random data w and process target data s in the memory 1 and writes the obtained concatenated data x∥r to the memory 1 (ST34).

The H′ function operation unit 6 executes the first random function H′ for the concatenated data x∥r in the memory 1 to calculate H′(x∥r)=w′ and writes obtained second first random data w′ to the memory 1.

The signature verification unit 8v determines whether the first and second first random data w and w′ in the memory 1 coincide with each other (ST35). If YES in step ST35, the signature verification unit 8v causes the arithmetic device 5 to separate the concatenated data x∥r and write the obtained document data x and random number r to the memory 1.

The input/output unit 2 outputs the document data x in the memory 1 (ST36).

If NO in step ST35, the signature verification unit 8v rejects the signature c′∥t and causes the input/output unit 2 to output and display a message representing that “the signature is rejected” (ST37). The processing is ended.

(Reason for Security of Signature Scheme)

The intuitive reason why the signature processing of this embodiment is safe can be explained as follows. That a signature scheme is safe intuitively means that any attacker cannot forge a signature for an arbitrary document. Assume a case in which an attacker generates a forged signature without breaking the one-way characteristic of the trapdoor one-way function.

As the best attack procedures for the attacker at this time, the signature candidate c′ is decided in advance. Then, the one-way function is caused to act on the signature candidate c′ in a calculable direction to set s=f(c′), thereby defining the document x. When c′ and s are defined, the attacker can obtain the value H(s) by using the second random function. The next procedure to be executed by the attacker is (i) defining the data t, (ii) defining the first random function value w, or (iii) defining a set of the document x and random number r.

When (i) the data t is defined, w is defined from the exclusive OR between the data t and already obtained H(s). The concatenated data x∥r is defined by the exclusive OR of s and w. However, because of the characteristic of the first random function H′, generally, H′(x∥r)=w does not hold. For this reason, no signature can be forged.

When (ii) the first random function value w is defined, the concatenated data x∥r is defined by the exclusive OR of s and w. However, because of the characteristic of the first random function H′, generally, H′(x∥r)=w does not hold. For this reason, no signature can be forged.

When (iii) a set of the document x and random number r is defined, w=H′(x∥r) can be defined by inputting the concatenated data x∥r to the first random function. However, because of the characteristic of the first random function, generally, the exclusive OR of x∥r and w does not equal s. For this reason, no signature can be forged.

(Security Against Active Attack)

Consider an attacker who attempts active attack for signature processing according to this embodiment. The attacker sends, to the authentic signer, a signature request for a document selected by the attacker himself/herself, receives a corresponding signature, and performs attack on the basis of information obtained at that time.

Information obtained by the signature request is information obtained by executing signature verification for the received signature c′∥t. The information contains [i] to [iii].
[i] The data w is output when the random number r is selected for the document x, and the concatenated data x∥r of the document and random number is input to the first random function H′.
[ii] For the data s of the exclusive OR between the concatenated data x∥r and the data w, the exclusive OR between the data w and H(s) obtained by inputting the data s to the second random function H equals the data t.
[iii] Inverse function operation f⁻¹(s) of the trapdoor one-way function equals the signed data c′.

Whether the signature scheme of this embodiment can successfully be done by active attack depends on whether the inverse function operation c′=f⁻¹(s) of the trapdoor one-way function can be calculated for the data s. Assume that as a result of active attack, the attacker calculates the data s by inputting the signed data c′ selected by himself/herself to the trapdoor one-way function and has a number of sets (s,c′=f⁻¹(s)).

At this time, assume that for a document x′ different from the document x output as the signature request, data s′ calculated by the exclusive OR between x′∥r′ and H′(x′∥r′) for an arbitrary random number r′ is present as (s′,c″) in a number of sets (s,c′=f⁻¹(s)) the attacker already has. In this case, a forged signature c″∥t′ can be output by calculating data t′ by the exclusive OR between H(s′) and H′(x′∥r′).

However, because of the characteristic of the first random function H′, it is difficult to find such an input that the calculation result of the exclusive OR between the input and the output coincides with a specific one of already stored sets. For this reason, the attack is impossible. Since it is difficult for the attacker to output a forged signature by using information obtained by active attack, the security of the signature scheme can be proved.

As described above, according to the second embodiment, even when the first embodiment is applied to signature processing and signature verification processing, the same functions and effects as in the first embodiment can be obtained.

### Third Embodiment

FIG. 11 is a schematic block diagram showing the arrangement of an encryption/signature apparatus according to the third embodiment of the present invention. This embodiment is a combination of the first and second embodiments. The apparatus comprises public key cryptography arithmetic units 8e, 8d, 8s, and 8v capable of executing all the above-described encryption processing, decryption processing, signature processing, and signature verification processing, and control units 9e, 9d, 9s, and 9v corresponding to the arithmetic units.

According to the above arrangement, encryption/signature apparatus usable for both processing operations of the first and second embodiments can be implemented. The encryption/signature apparatus according to the third embodiment can execute encryption processing (8e and 9e), decryption processing (8d and 9d), signature processing (8s and 9s), and signature verification processing (8v and 9v). However, the present invention is not limited to this. The apparatus may be modified to an arrangement capable of executing, e.g., encryption processing and decryption processing. Similarly, the apparatus may be modified to an arrangement capable of executing, e.g., signature processing and signature verification processing. Alternatively, the apparatus may be modified to an arrangement capable of executing, e.g., encryption processing and signature processing. Similarly, the apparatus may be modified to an arrangement capable of executing, e.g., decryption processing and signature verification processing. In addition, this embodiment can also be modified to an arrangement capable of executing a combination of arbitrary two or three of encryption processing, decryption processing, signature processing, and signature verification processing.

### Fourth Embodiment

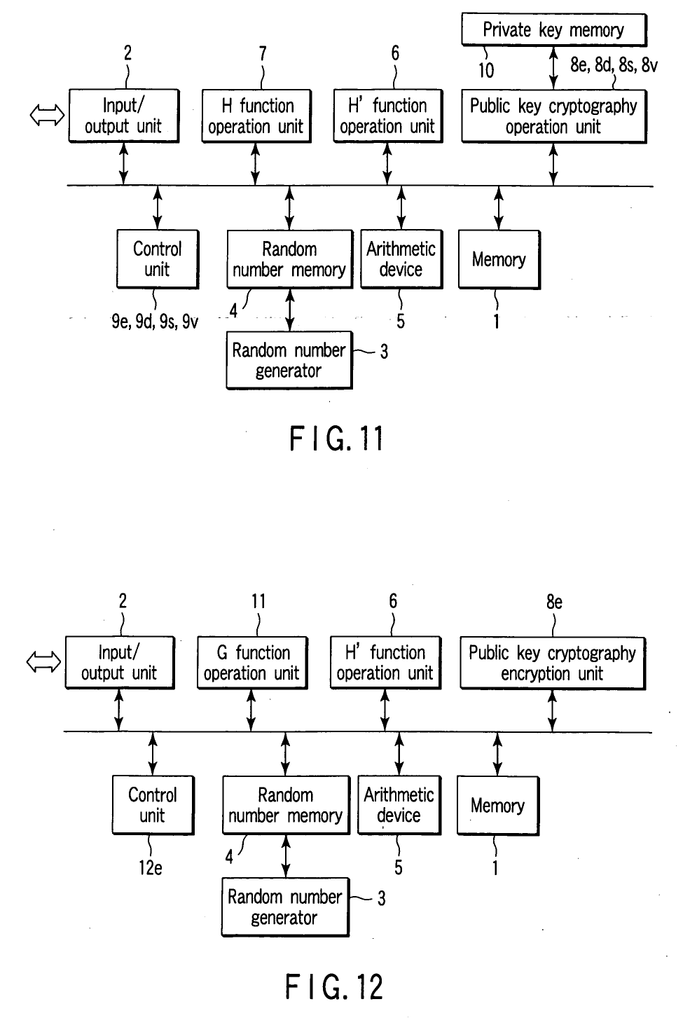

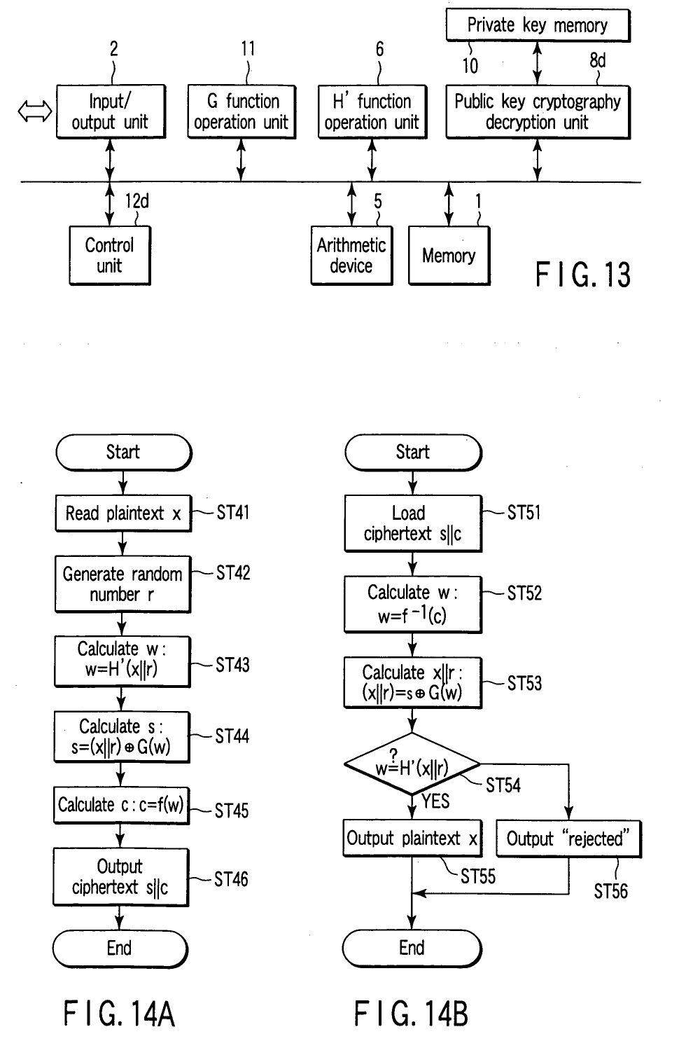

FIG. 12 is a schematic block diagram showing the arrangement of an encryption apparatus according to the fourth embodiment of the present invention. FIG. 13 is a schematic block diagram showing the arrangement of a decryption apparatus according to the fourth embodiment.

This embodiment is a modification to the first embodiment. In the fourth embodiment, scheme 2 shown in FIG. 3B is executed in place of scheme 1 shown in FIG. 3A. Each apparatus comprises a G function operation unit 11 in place of the H function operation unit 7 of scheme 1. The apparatuses respectively comprise control units 12e and 12d of scheme 2 in place of the control units 9e and 9d of scheme 1. The output from an H′ function operation unit 6 is directly input to a public key cryptography arithmetic unit. Hence, the output size of the H′ function operation unit 6 is equal to or larger than the input size of a trapdoor one-way function f used in the public key encryption scheme.

The G function operation unit 11 of each of the encryption apparatus and decryption apparatus has a function of executing a second random function G for first random data w in a memory 1, and a function of writing obtained second random data G(w) in the memory 1. The second random data G(w) has a size equal to or larger than that of concatenated data x∥r. More specifically, to mask the concatenated data x∥r by using the output G(w), the second random function G of the encryption apparatus must output the data G(w) having a size equal to or larger than that of the concatenated data x∥r in correspondence with input data having an arbitrary size.

The control unit 12e of the encryption apparatus controls the units 1 to 11 such that received plaintext data x is encrypted on the basis of the plaintext data x and a public key pk of the public key encryption scheme, and an obtained ciphertext s∥c is output. More specifically, the control unit 12e has a function of controlling the units 1 to 11 as shown in FIG. 14A.

The control unit 12d of the decryption apparatus controls the units 1 to 11 such that when the ciphertext s∥c obtained by the encryption apparatus is input, the ciphertext s∥c is decrypted on the basis of the ciphertext s∥c and a private key sk of the public key encryption scheme, and the obtained plaintext data x is output. More specifically, the control unit 12d has a function of controlling the units 1 to 11 as shown in FIG. 14B.

The operations of the encryption and decryption apparatuses having the above arrangements will be described next with reference to the flowcharts shown in FIGS. 14A and 14B.

(Encryption Processing)

A ciphertext sender uses the encryption apparatus to encrypt a plaintext and transmit ciphertext to a ciphertext recipient. In this encryption apparatus, the units 1 to 11 are operated by the control unit 12e as shown in FIG. 14A.

First, steps ST41 to ST43 are executed as in steps ST1 to ST3 described above. More specifically, from the concatenated data x∥r of the plaintext data x and a random number r, H′(x∥r)=w is calculated. The obtained first random data w is written to the memory 1. The size of the first random data w is equal to or larger than the input size of the public key encryption scheme.

The G function operation unit 11 executes the second random function G for the first random data w in the memory 1 and writes the obtained second random data G(w) to the memory 1. The size of the second random data G(w) is equal to or larger than that of the concatenated data x∥r.

The arithmetic device 5 calculates the exclusive OR between the concatenated data x∥r and the second random data G(w) in the memory 1 and writes obtained padding data s to the memory 1 (ST44).

The public key cryptography encryption unit 8e executes encryption processing for the first random data w in the memory 1 on the basis of the public key pk in the memory 1 in accordance with the public key encryption scheme using the one-way function f and writes obtained encrypted data c to the memory 1 (ST45). The public key pk belongs to a ciphertext recipient who uses the decryption apparatus.

The arithmetic device 5 concatenates the encrypted data c and padding data s in the memory 1 and writes the obtained ciphertext s∥c to the memory 1.

The input/output unit 2 outputs and displays a message representing that creation of the ciphertext s∥c is ended. The input/output unit 2 outputs and transmits the ciphertext s∥c in the memory 1 to the ciphertext recipient (decryption apparatus) in accordance with the User operation (ST46).

(Decryption Processing)

The ciphertext recipient uses the decryption apparatus to decrypt a ciphertext to obtain a plaintext. In this decryption apparatus, the units 1 to 11 are operated by the control unit 12d as shown in FIG. 14B.

The input/output unit 2 loads the ciphertext s∥c transmitted from the ciphertext sender and stores the ciphertext in the memory 1 (ST51).

The arithmetic device 5 separates the ciphertext s∥c in the memory 1 into the encrypted data c and padding data s and writes them to the memory 1.

The public key cryptography decryption unit 8d decrypts the encrypted data c in the memory 1 on the basis of the private key sk in the private key memory 10 in accordance with the public key encryption scheme and writes the obtained first first random data w to the memory 1 (ST52).

The G function operation unit 11 executes the second random function G for the first first random data w in the memory 1 and writes the obtained second random data G(w) to the memory 1.

The arithmetic device 5 calculates the exclusive OR between the second random data G(w) and padding data s in the memory 1 and writes the obtained concatenated data x∥r to the memory 1 (ST53).

The H′ function operation unit 6 executes the first random function H′ for the concatenated data x∥r in the memory 1 to calculate H′(x∥r)=w′ and writes obtained second first random data w′ to the memory 1.

The control unit 12d determines whether the first and second first random data w and w′ in the memory 1 coincide with each other (ST54).

If YES in step ST54, the control unit 12d causes the arithmetic device 5 to separate the concatenated data x∥r and write the obtained plaintext data x and random number r to the memory 1.

The input/output unit 2 outputs the plaintext data x in the memory 1 (ST55).

If NO in step ST54, the control unit 12d rejects the ciphertext s∥c and causes the input/output unit 2 to output and display a message representing that “the ciphertext is rejected” (ST56). The processing is ended.

(Roles of Random Number r and Random Functions H′ and G)

The roles of the random number r, first random function H′, and second random function G in the above-described operations will be described next.

The random number r is used to execute the encryption scheme at random, as in the first to third embodiments. Generally, a value of 80 to 160 bits suffices.

The first random function H′ is used to guarantee the authenticity of a decrypted text obtained by decryption and the authenticity of a signature in signature verification, as in the first to third embodiments.

The second random function G is used to mask the concatenated data x∥r of a plaintext and a random number to guarantee the security of the encryption scheme. In this embodiment, when the public key encryption scheme is safe, i.e., the trapdoor one-way function has a one-way characteristic, an attacker other than the authentic decrypter cannot obtain the input w from the ciphertext s∥c to the second random function F. For this reason, the attacker cannot unmask the concatenated data x∥r. It is difficult to obtain the information about the plaintext x.

(Reason for Security of Encryption Scheme)

The intuitive reason why the encryption processing of this embodiment is safe if the encryption function satisfies the one-way characteristic can be explained as follows. If an attacker who has received the ciphertext s∥c wants to obtain information about a corresponding plaintext, he/she must obtain the inverse function value w=f⁻¹(c) of c.

The reason why the encryption is safe will be described. If the attacker cannot decrypt w, the value G(w) cannot be specified-because of the characteristic of the second random function G. At this time, the probability of success of estimation for bits 0 and 1 of G(w) by the attacker is only 1/2. Hence, the attacker cannot specify the concatenated data x∥r calculated from the exclusive OR of the data t and G(w). For this reason, the attacker cannot obtain even 1-bit information about the plaintext.

More specifically, it is difficult to obtain information about a plaintext without obtaining the inverse function value w=f⁻¹(c). To break the encryption scheme, w=f⁻¹(c) must be obtained by breaking the one-way characteristic of the trapdoor one-way function.

(Security Against Active Attack)

Consider an attacker who attempts active attack for encryption processing according to this embodiment. The attacker sends a ciphertext decryption request to the authentic decrypter, receives a corresponding plaintext or a reply indicating that the ciphertext is illicit, and performs attack on the basis of information obtained at that time.

However, the attacker cannot obtain information about the plaintext. More specifically, the attacker can receive a corresponding plaintext only when a ciphertext generated by himself/herself in accordance with the encryption procedures is output as a decryption request text. Inversely, when the attacker sends, as a decryption request text, data generated without complying with the encryption procedures, he/she can only obtain a reply indicating that the decryption request text is an illicit ciphertext. The reason for this can be explained in the following way.

The decryption apparatus rejects the ciphertext s∥c as an illicit ciphertext if H′(x∥r)=w does not hold at the time of decryption.

Assume that s_{O}∥c_{O} is a decryption request text output from the attacker. Let w_{O} be data calculated from the decryption request text s_{O}∥c_{O} in accordance with the decryption procedures, x_{O} be a plaintext, and r_{O} be a random number. Data w_{O}=f⁻¹(c_{O}).

At this time, if the attacker outputs the decryption request text s_{O}∥c_{O} in accordance with encryption procedures, the attacker should have calculated a random function value by inputting x_{O}∥r_{O} to the first random function H′ and also calculated a random function value by inputting w_{O} to the second random function G by himself/herself.

Outputting the decryption request text without complying with the encryption procedures means that the random function value G(w_{O}) or H′(x_{O}∥r_{O}) is not calculated.

First, assume a case in which the attacker outputs the decryption request text s_{O}∥c_{O} without calculating the random function value G(w_{O}). Because of the characteristic of the second random function G, G(w_{O}) is a random value. The value w_{O}∥r_{O} calculated by the exclusive OR between G(w_{O}) and the decryption request text s_{O} is a random value, too. At this time, the random value w_{O}∥r_{O} does not generally satisfy H′(x_{O}∥r_{O})=w_{O}. For this reason, the attacker can only obtain a reply indicating that the decryption request text is an illicit ciphertext.

Next, assume a case in which the attacker generates the decryption request text s_{O}∥c_{O} but not by obtaining the random function value H′(x_{O}∥r_{O}) by obtaining the random function value G(w_{O}). Because of the characteristic of the first random function H′, generally, H′(x_{O}∥r_{O})=w_{O} does not hold. For this reason, the attacker can only obtain a reply indicating that the decryption request text is an illicit ciphertext.

Since it is difficult for the attacker to obtain information even by active attack, the security of encryption processing can be proved.

(Comparison with Prior Art)

This embodiment is similar to the conventional PSS-ES scheme in some points. However, the fourth embodiment is different from the PSS-ES scheme in that not entire data but one of two divided parts of padding data is used as the input range of the trapdoor one-way function. As described above, this embodiment can guarantee security for the one-way characteristic of the trapdoor one-way function. However, when the PSS-ES scheme is used as an encryption scheme, it cannot present security only with the one-way characteristic. An example of attack will be described below.

The PSS-ES scheme uses the same padding scheme as in the fourth embodiment. More specifically, in encrypting the plaintext x, the ciphertext generator generates the random number r and generates the data w by inputting the concatenated data x∥r of the plaintext x and random number r to the first random function H′. Next, the ciphertext generator calculates the exclusive OR between the concatenated data x∥r and G(w) obtained by inputting the data w to the second random function G, thereby generating the data s. The ciphertext generator generates a ciphertext y by inputting the concatenated data s∥w of the data s and w to an encryption function corresponding to the public key of the ciphertext recipient.

Consider a case in which the encryption function is a one-way function. An example of attack for breaking the encryption scheme will be described. Assume that the encryption function has a characteristic representing that although it is difficult to wholly decrypt f⁻¹(y)=s∥w for the function value y, the start bit s_{O} of the data s and each bit corresponding to w can be calculated. Generally, in some cases, decrypting partial information of f⁻¹(y) is easier than to decrypting the entire data. Hence, it is meaningful to consider a one-way function having such a characteristic.

Consider an attacker for a PSS-ES scheme constituted by using this one-way function. As an object of this attacker, when the ciphertext y is given, he/she will obtain some information of a plaintext corresponding to the ciphertext y. The attacker who has received the ciphertext y reconstructs the start bit s_{O} of the data s and the data w. Next, the attacker obtains G(w) by inputting the data w to the second random function G. Let g_{O} be the start bit of the data G(w). The attacker can obtain the value of the start bit x_{O} of the plaintext x corresponding to the ciphertext y by calculating the exclusive OR of the start bits s_{O} and g_{O}.

Hence, the attacker can obtain the information of the corresponding plaintext from the ciphertext without obtaining the remaining bits of the data s and wholly reconstructing f⁻¹(y), i.e., without breaking the one-way characteristic of the encryption function.

As described above, the PSS-ES scheme cannot present security depending on the one-way characteristic of the encryption function. To guarantee security of the PSS-ES scheme, it is necessary to use an encryption function which makes it difficult to particularly obtain, of f⁻¹(y), a bit corresponding to the data w. At this time, the above attack example cannot be applied, and the security can be proved. The function that satisfies the above characteristic is called a partial-domain one-way function.

However, the partial-domain one-way function is more restricted than the one-way function. Even when security can be presented depending on the partial-domain one-way characteristic of the partial-domain one-way function, the encryption scheme cannot be supposed to have tight security.

To guarantee predetermined security level by the PSS-ES scheme, a measure such as increasing the key size must be taken. This increases the key storage area and calculation cost.

As described above, according to this embodiment, as in the first embodiment, the ciphertext s∥c is created as concatenated data obtained by concatenating the two data s and c, and the concatenated data is created by using the public key encryption scheme for only one (necessary part w) of the data. For this reason, tight security for the one-way characteristic of the trapdoor one-way function of the public key encryption scheme can be implemented. Accordingly, a predetermined security level can be guaranteed by a key with a smaller size. Hence, the storage area where the key is recorded can be reduced, and the calculation cost can also be reduced.

In this embodiment, the assumption for the trapdoor one-way function of the public key encryption scheme is limited to the deterministic encryption represented by RSA encryption so that the third random function H of the conventional REACT-ES scheme can be omitted. For this reason, the number of times of use of random functions can be reduced to two. Accordingly, the calculation time can be shortened. For example, in the REACT-ES scheme, the public key encryption operation, which requires much higher calculation cost than exclusive OR arithmetic and random function operation, is executed, and then, the third random function operation is executed. For this reason, the entire calculation slows. In the fourth embodiment, however, the second random function operation and the exclusive OR operation between the output G(w) of the second random function and the concatenated data x∥r are processed in parallel with the public key encryption operation. For this reason, a ciphertext can quickly be generated without any delay in calculation.

As described above, in this embodiment, both tight security and random function operation less than three times can simultaneously be implemented.

In this embodiment, identical functions can be used as the first random function H′ and second random function G, as in the above-described embodiments, so that the number of random function operation units 6 and 11 can be reduced to only one.

In this embodiment, as in the above-described embodiments, the size of the first random function H′ can be larger than that of the size k of the key used in the public key encryption system. In this case, only the partial information of w, which has a length equal to the size k of the key used in the public key encryption system, is encrypted. The remaining part of w is attached together with the encryption result.

To unmask the data, as in the above-described embodiments, it is necessary to execute inverse function operation of the trapdoor one-way function. However, the encryption scheme or signature scheme cannot be broken without breaking the one-way characteristic of the trapdoor one-way function. For this reason, even the method of encrypting only part of w and attaching the remaining unencrypted part can be supposed to have tight security depending on the one-way characteristic of the trapdoor one-way function.

### Fifth Embodiment

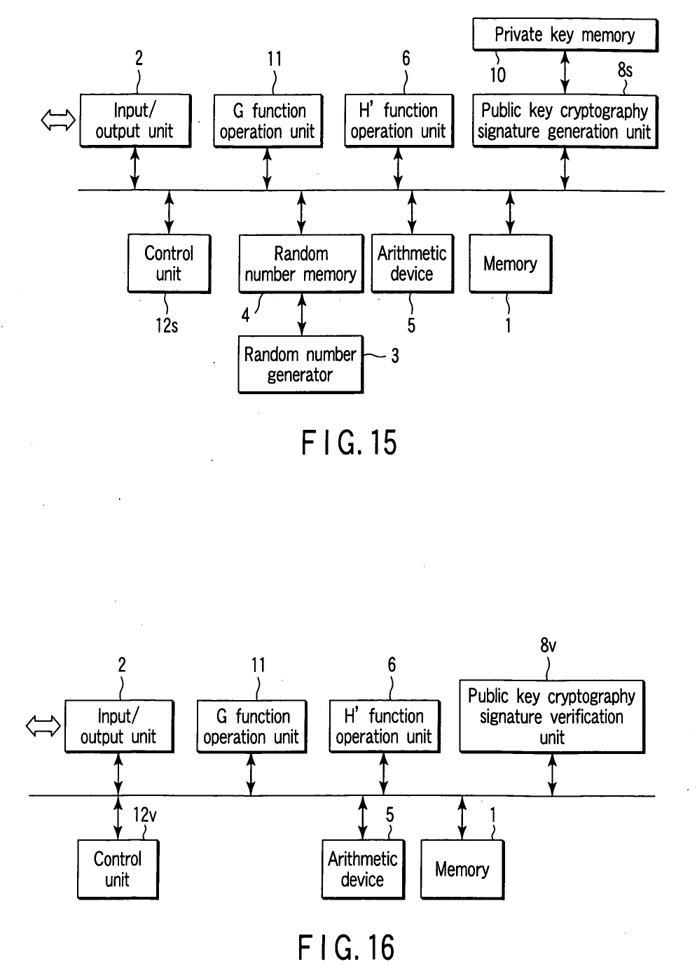

FIG. 15 is a schematic block diagram showing the arrangement of a signature apparatus according to the fifth embodiment of the present invention. FIG. 16 is a schematic block diagram showing the arrangement of a signature verification apparatus according to the fifth embodiment.

This embodiment is a modification to the second embodiment. In the fifth embodiment, scheme 2 shown in FIG. 3B is executed in place of scheme 1 shown in FIG. 3A. Each apparatus comprises a G function operation unit 11 in place of the H function operation unit 7 of scheme 1. The apparatuses respectively comprise control units 12s and 12v of scheme 2 in place of the control units 9e and 9d of scheme 1. The output from an H′ function operation unit 6 and the G function operation unit 11 are the same as described above in the fourth embodiment.

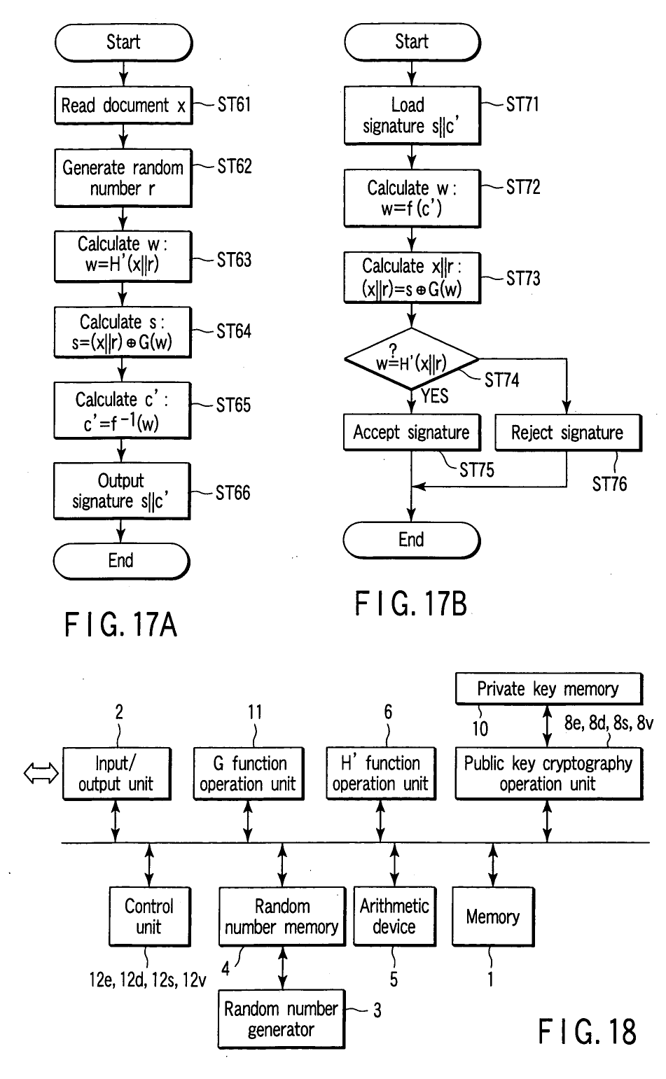

The control unit 12s of the signature apparatus controls units 1 to 11 such that received document data x is signed on the basis of the document data x and a private key sk of the public key encryption scheme, and obtained signature s∥c′ is output. More specifically, the control unit 12s has a function of controlling the units 1 to 11 as shown in FIG. 17A.

The control unit 12v of the signature verification apparatus controls the units 1 to 11 such that when the signature s∥c′ obtained by the signature apparatus is input, the authenticity of the signature is verified on the basis of the signature s∥c′ and a public key pk of the public key encryption scheme. More specifically, the control unit 12v has a function of controlling the units 1 to 11 as shown in FIG. 17B.

The operations of the signature and signature verification apparatuses having the above arrangements will be described next with reference to the flowcharts shown in FIGS. 17A and 17B.

(Signature Processing)

A signature generator uses the signature apparatus to transmit a signature obtained by signing a document to a signature verifier. In this signature apparatus, the units 1 to 11 are operated by the control unit 12s as shown in FIG. 17A.

First, steps ST61 to ST63 are executed as in steps ST21 to ST23 described above. More specifically, from concatenated data x∥r of the plaintext data x and a random number r, H′(x∥r)=w is calculated. Obtained first random data w is written to the memory 1. The size of the first random data w is equal to or larger than the input size of the public key encryption scheme.

The G function operation unit 11 executes a second random function G for the first random data w in the memory 1 and writes obtained second random data G(w) in the memory 1. The size of the second random data G(w) is equal to or larger than that of the concatenated data x∥r.

The arithmetic device 5 calculates the exclusive OR between the concatenated data x∥r and the second random data G(w) in the memory 1 and writes obtained padding data s to the memory 1 (ST64).

The public key cryptography signature generation unit 8s executes signature processing for the first random data w in the memory 1 on the basis of the private key sk in the private key memory 10 in accordance with the public key encryption scheme using a one-way function f and writes obtained signed data c′ to the memory 1 (ST65). The private key sk belongs to a signature generator who uses the signature apparatus.

The arithmetic device 5 concatenates the signed data c′ and padding data s in the memory 1 and writes the obtained signature s∥c′ to the memory 1.

The input/output unit 2 outputs and displays a message representing that creation of the signature s∥c′ is ended. The input/output unit 2 outputs and transmits the document data x and signature s∥c′ in the memory 1 to the signature verifier (signature verification apparatus) (ST66).

(Signature Verification Processing)

The signature verifier uses the signature verification apparatus to verify the authenticity of a signature. In this signature verification apparatus, the units 1 to 11 are operated by the control unit 12v as shown in FIG. 17B.

The input/output unit 2 loads the document data x and signature s∥c′ transmitted from the signature generator and stores them in the memory 1 (ST71).

The arithmetic device 5 separates the signature s∥c′ in the memory 1 into the signed data c′ and padding data s and writes them to the memory 1.

The public key cryptography signature verification unit 8v reconstructs the signed data c′ in the memory 1 on the basis of the public key pk in accordance with the public key encryption scheme and writes the obtained first first random data w to the memory 1 (ST72).

The G function operation unit 11 executes the second random function G for the first first random data w in the memory 1 and writes the obtained second random data G(w) to the memory 1.

The arithmetic device 5 calculates the exclusive OR between the second random data G(w) and padding data s in the memory 1 and writes the obtained concatenated data x∥r to the memory 1 (ST73).

The H′ function operation unit 6 executes the first random function H′ for the concatenated data x∥r in the memory 1 to calculate H′(x∥r)=w′ and writes obtained second first random data w′ to the memory 1.

The signature verification unit 8v determines whether the first and second first random data w and w′ in the memory 1 coincide with each other (ST74). If YES in step ST74, the signature verification unit 8v causes the arithmetic device 5 to separate the concatenated data x∥r and write the obtained document data x and random number r to the memory 1.

The input/output unit 2 outputs the document data x in the memory 1 (ST75).

If NO in step ST74, the signature verification unit 8v rejects the signature s∥c′ and causes the input/output unit 2 to output and display a message representing that “the signature is rejected” (ST76). The processing is ended.

(Reason for Security of Signature Scheme)

The intuitive reason why the signature processing of this embodiment is safe can be explained as follows. Assume a case in which an attacker generates a forged signature without breaking the one-way characteristic of the trapdoor one-way function.

As the best attack procedures for the attacker at this time, the signature candidate c′ is decided in advance. Then, the one-way function is caused to act on the signature candidate c′ in a calculable direction to set w=f(c′), thereby defining the document x. When c′ and w are defined, the attacker can obtain the value G(w) by using the second random function. The next procedure to be executed by the attacker is defining the signature s, or defining a set of the document x and random number r.

When the signature s is defined, the concatenated data x∥r is defined from the exclusive OR between the signature s and already obtained G(w). However, because of the characteristic of the first random function H′, generally, H′(x∥r)=w does not hold. For this reason, no signature can be forged.

On the other hand, when a set of the document x and random number r is defined, the value H′(x∥r) generated from the concatenated data x∥r has a value different from w because of the characteristic of the first random function. For this reason, no signature can be forged.

(Security Against Active Attack)

Consider an attacker who attempts active attack for signature processing according to this embodiment. The attacker sends, to the authentic signer, a signature request for a document selected by the attacker himself/herself, receives a corresponding signature, and performs attack on the basis of information obtained at that time.

Information obtained by the signature request is information obtained by executing signature verification for the received signature s∥c′. The information contains [i] to [iii], as in the above-described embodiment.
[i] The data w is output when the random number r is selected for the document x, and the concatenated data x∥r of the document and random number is input to the first random function H′.
[ii] The exclusive OR between G(w) obtained from the data w and the concatenated data x∥r equals the data s.
[iii] For the data w, inverse function operation f⁻¹(w) of the trapdoor one-way function equals the signed data c′.

Whether the signature scheme of this embodiment can successfully be done by active attack depends on whether the inverse function operation c′=f⁻¹(w) of the trapdoor one-way function can be calculated for the data w. Assume that as a result of active attack, the attacker calculates the data w by inputting the signed data c′ selected by himself/herself to the trapdoor one-way function and has a number of sets (w,c′=f⁻¹(w)).

At this time, assume that for a document x′ different from the document x output as the signature request, w′=H′(x∥r′) obtained by inputting x′∥r′ to the first random function H′ for an arbitrary random number r′ is present as (w′,c″) in a number of sets (w,c′=f⁻¹(w)) the attacker already has. In this case, a forged signature s′∥c″ can be output by calculating data s′ by the exclusive OR between G(w′) and x′∥r′.

However, because of the characteristic of the first random function H′, it is difficult to find such an input that the output of the random function H′ coincides with a specific one of already stored sets. For this reason, the attack is impossible. Since it is difficult for the attacker to output a forged signature by using information obtained by active attack, the security of the signature scheme can be proved.

### Sixth Embodiment

FIG. 18 is a schematic block diagram showing the arrangement of an encryption/signature apparatus according to the sixth embodiment of the present invention. This embodiment is a combination of the fourth and fifth embodiments. The apparatus comprises public key cryptography arithmetic units 8e, 8d, 8s, and 8v capable of executing all the above-described encryption processing, decryption processing, signature processing, and signature verification processing, and control units 12e, 12d, 12s, and 12v corresponding to the arithmetic units.

According to the above arrangement, encryption/signature apparatus usable for both processing operations of the fourth and fifth embodiments can be implemented. This embodiment can also be modified to an arrangement capable of executing a combination of arbitrary two or three of encryption processing, decryption processing, signature processing, and signature verification processing, as in the third embodiment.

The method described in each embodiment can be stored, as a program executable by a computer, on a storage medium such as a magnetic disk (e.g., floppy (registered trademark) disk or hard disk), optical disk (e.g., CD-ROM or DVD), magneto-optical disk (MO), or semiconductor memory, and distributed.

The storage medium can have any storage format as long as it is a storage medium which can store a program and be read by a computer.

Some of processes to implement the embodiment may be executed by an OS (Operating System) or MW (middleware) such as database management software or network software running on a computer on the basis of instructions of a program installed from a storage medium in the computer.

The storage medium of the present invention is not limited to a medium separated from the computer. It also includes a storage medium which downloads the program transmitted over a LAN or the Internet and stores or temporarily stores the program.

The number of storage media is not limited to one. The storage medium of the present invention also includes a case in which the processing of the embodiment is executed from a plurality of media. Any medium arrangement can be used.

The computer of the present invention executes each processing of the embodiment on the basis of the program stored on the storage medium. The computer can be either a single apparatus such as a personal computer or a system formed by concatenating a plurality of apparatuses through a network.

The computer of the present invention is not limited to a personal computer and also includes an arithmetic processing apparatus or microcomputer included in an information processing device. “Computer” is a general term for devices and apparatuses capable of implementing the function of the present invention by a program.

The present invention is not limited to the above-described embodiments. Accordingly, in practicing the invention, various modifications of constituent elements can be made without departing from its spirit or scope. In addition, various inventions can be formed by appropriately combining a plurality of constituent elements disclosed in the embodiments. For example, some constituent elements may be omitted from those described in the embodiments. Alternatively, constituent elements of different embodiments may appropriately be combined.

1. An encryption/signature method used in an encryption/signature apparatus which can execute encryption processing and signature processing by a public key encryption scheme using a plurality of random functions, comprising:
inputting target data x of one of encryption processing and signature processing;
generating a random number r to be concatenated to the target data x;
concatenating the target data x and the random number r to obtain concatenated data x∥r;
executing a first random function H′ for the concatenated data x∥r to calculate H′(x∥r)=w and generate first random data w having a size not less than that of the concatenated data x∥r;
generating process target data s by calculating an exclusive OR between the concatenated data x∥r and the first random data w;
executing a second random function H for the process target data s to generate second random data H(s) having the same size as that of the first random data w;
generating padding data t by calculating an exclusive OR between the first random data w and the second random data H(s);
executing one of encryption processing and signature processing for the process target data s by the public key encryption scheme; and
concatenating the padding data t and one of encrypted data c and signed data c′ obtained by execution and outputting one of an obtained ciphertext c∥t and signature c′∥t.

2. An encryption/signature apparatus which can execute encryption processing and signature processing by a public key encryption scheme using a plurality of random functions, comprising:
an input device which inputs target data x of one of encryption processing and signature processing;
a random number generator which generates a random number r to be concatenated to the target data x;
a first concatenation device which concatenates the target data x and the random number r to obtain concatenated data x∥r;
first random function operation means for executing a first random function H′ for the concatenated data x∥r to calculate H′(x∥r)=w and generate first random data w having a size not less than that of the concatenated data x∥r;
a process target data generation device which generates process target data s by calculating an exclusive OR between the concatenated data x∥r and the first random data w;
second random function operation means for executing a second random function H for the process target data s to generate second random data H(s) having the same size as that of the first random data w;
a padding data generation device which generates padding data t by calculating an exclusive OR between the first random data w and the second random data H(s);
encryption/signature means for executing one of encryption processing and signature processing for the process target data s by the public key encryption scheme;
a second concatenation device which concatenates the padding data t and one of encrypted data c and signed data c′ obtained by execution; and
an output device which outputs one of a ciphertext c∥t and a signature c′∥t, which is obtained by the second concatenation device.

3. An encryption/signature apparatus which can execute encryption processing and signature processing by a public key encryption scheme using a plurality of random functions, comprising:
an input device which inputs target data x of one of encryption processing and signature processing;
a random number generator which generates a random number r to be concatenated to the target data x;
a first concatenation device which concatenates the target data x and the random number r to obtain concatenated data x∥r;
first random function operation device which executes a first random function H′ for the concatenated data x∥r to calculate H′(x∥r)=w and generate first random data w having a size not less than that of the concatenated data x∥r;
a process target data generation device which generates process target data s by calculating an exclusive OR between the concatenated data x∥r and the first random data w;
second random function operation device which executes a second random function H for the process target data s to generate second random data H(s) having the same size as that of the first random data w;
a padding data generation device which generates padding data t by calculating an exclusive OR between the first random data w and the second random data H(s);
encryption/signature device which executes one of encryption processing and signature processing for the process target data s by the public key encryption scheme;
a second concatenation device which concatenates the padding data t and one of encrypted data c and signed data c′ obtained by execution; and
an output device which outputs one of a ciphertext c∥t and a signature c′∥t, which is obtained by the second concatenation device.

4. An encryption apparatus which encrypts received plaintext data x on the basis of the plaintext data x and a public key pk of a public key encryption scheme and outputs an obtained ciphertext, comprising:
a random number generator which generates a random number r to be concatenated to the plaintext data x;
a first concatenation device which concatenates the plaintext data x and the random number r to obtain concatenated data x∥r;
first random function operation means for executing a first random function H′ for the concatenated data x∥r to calculate H′(x∥r)=w and generate first random data w having a size not less than that of the concatenated data x∥r;
a process target data generation device which generates process target data s by calculating an exclusive OR between the concatenated data x∥r and the first random data w;
second random function operation means for executing a second random function H for the process target data s to calculate second random data H(s) having the same size as that of the first random data w;
a padding data generation device which generates padding data t by calculating an exclusive OR between the first random data w and the second random data H(s);
encryption means for encrypting the process target data s on the basis of the public key pk by the public key encryption scheme;
a second concatenation device which concatenates the padding data t and encrypted data c obtained by encryption processing to obtain a ciphertext c∥t; and
an output device which outputs the ciphertext c∥t.

5. A decryption apparatus which, when a ciphertext c∥t is received, decrypts the ciphertext c∥t on the basis of the ciphertext c∥t and a private key sk of a public key encryption scheme and outputs obtained plaintext data x, the ciphertext c∥t being created from first random data w=H′(x∥r) obtained by executing a first random function H′ for concatenated data x∥r of the plaintext data x and a random number r, process target data s obtained from an exclusive OR between the concatenated data x∥r and the first random data w, second random data H(s) obtained by executing a second random function H for the process target data s, padding data t obtained from an exclusive OR between the first random data w and the second random data H(s), and encrypted data c obtained by encrypting the process target data s on the basis of a public key pk, and the ciphertext c∥t being obtained by concatenating the encrypted data c and the padding data t, comprising:
a first separation device which separates the ciphertext c∥t into the encrypted data c and the padding data t;
decryption means for decrypting the encrypted data c on the basis of the private key sk by the public key encryption scheme to obtain the process target data s;
second random function operation means for executing the second random function H for the process target data s to calculate the second random data H(s);
a first random data generation device which generates the first first random data w by calculating an exclusive OR between the second random data H(s) and the padding data t;
a concatenated data generation device which generates the concatenated data x∥r by calculating an exclusive OR between the first random data w and the process target data s;
second random data generation device which generates second first random data w′ by executing the first random function H′ for the concatenated data x∥r to calculate H′(x∥r)=w′;
determination means for determining whether the first random data w and the second first random data w′ coincide with each other;
a second separation device which, when it is determined that the first random data w and the second first random data w′ coincide with each other, separates the concatenated data x∥r to obtain the plaintext data x and the random number r; and
an output device which outputs the plaintext data x.

6. A signature apparatus which signs received document data x on the basis of the document data x and a private key sk of a public key encryption scheme and outputs an obtained signature, comprising:
a random number generator which generates a random number r to be concatenated to the document data x;
a first concatenation device which concatenates the document data x and the random number r to obtain concatenated data x∥r;
first random function operation means for executing a first random function H′ for the concatenated data x∥r to calculate H′(x∥r)=w and generate first random data w having a size not less than that of the concatenated data x∥r;
a process target data generation device which generates process target data s by calculating an exclusive OR between the concatenated data x∥r and the first random data w;
second random function operation means for executing a second random function H for the process target data s to calculate second random data H(s) having the same size as that of the first random data w;
a padding data generation device which generates padding data t by calculating an exclusive OR between the first random data w and the second random data H(s);
signature means for signing the process target data s on the basis of the private key sk by the public key-encryption scheme;
a second concatenation device which concatenates the padding data t and signed data c′ obtained by signature processing to obtain a signature c′∥t; and
an output device which outputs the signature c′∥t.

7. A signature verification apparatus which, when a signature c′∥t is received, verifies authenticity of the signature c′∥t on the basis of the signature c′∥t and a public key pk of a public key encryption scheme, the signature c′∥t being created from first random data w=H′(x∥r) obtained by executing a first random function H′ for concatenated data x∥r of document data x and a random number r, process target data s obtained from an exclusive OR between the concatenated data x∥r and the first random data w, second random data H(s) obtained by executing a second random function H for the process target data s, padding data t obtained from an exclusive OR between the first random data w and the second random data H(s), and signed data c′ obtained by signing the process target data s on the basis of a private key sk by the public key encryption scheme, and the signature c′∥t being obtained by concatenating the signed data c′ and the padding data t, comprising:
a first separation device which separates the signature c′∥t into the signed data c′ and the padding data t;
reconstruction means for reconstructing the signed data c′ on the basis of the public key pk by the public key encryption scheme to obtain the process target data s;
second random function operation means for executing the second random function H for the process target data s to calculate the second random data H(s);
a first random data generation device which generates the first first random data w by calculating an exclusive OR between the second random data H(s) and the padding data t;
a concatenated data generation device which generates the concatenated data x∥r by calculating an exclusive OR between the first random data w and the process target data s;
second random data generation device which generates second first random data w′ by executing the first random function H′ for the concatenated data x∥r to calculate H′(x∥r)=w′;
determination means for determining whether the first random data w and the second first random data w′ coincide with each other;
signature accepting means for, when it is determined that the first random data w and the second first random data w′ coincide with each other, accepting the signature c′∥t as an authentic signature.

8. A signature verification apparatus which, when a signature c′∥t is received, verifies authenticity of the signature c′∥t on the basis of the signature c′∥t and a public key pk of a public key encryption scheme, the signature c′∥t being created from first random data w=H′(x∥r) obtained by executing a first random function H′ for concatenated data x∥r of document data x and a random number r, process target data s obtained from an exclusive OR between the concatenated data x∥r and the first random data w, second random data H(s) obtained by executing a second random function H for the process target data s, padding data t obtained from an exclusive OR between the first random data w and the second random data H(s), and signed data c′ obtained by signing the process target data s on the basis of a private key sk by the public key encryption scheme, and the signature c′∥t being obtained by concatenating the signed data c′ and the padding data t, comprising:
a first separation device which separates the signature c′∥t into the signed data c′ and the padding data t;
reconstruction device which reconstructs the signed data c′ on the basis of the public key pk by the public key encryption scheme to obtain the process target data s;
second random function operation device which executes the second random function H for the process target data s to calculate the second random data H(s);
a first random data generation device which generates the first first random data w by calculating an exclusive OR between the second random data H(s) and the padding data t;
a concatenated data generation device which generates the concatenated data x∥r by calculating an exclusive OR between the first random data w and the process target data s;
second random data generation device which generates second first random data w′ by executing the first random function H′ for the concatenated data x∥r to calculate H′(x∥r)=w′;
determination device which determines whether the first random data w and the second first random data w′ coincide with each other;
signature accepting device, when it is determined that the first random data w and the second first random data w′ coincide with each other, accepts the signature c′∥t as an authentic signature.

9. A program which is stored on a computer-readable storage medium and used in a computer of an encryption/signature apparatus which can execute encryption processing and signature processing by a public key encryption scheme using a plurality of random functions, comprising:
a first program code for causing the computer to execute processing for inputting target data x of one of encryption processing and signature processing;
a second program code for causing the computer to execute processing for generating a random number r to be concatenated to the target data x;
a third program code for causing the computer to execute processing for concatenating the target data x and the random number r to obtain concatenated data x∥r;
a fourth program code for causing the computer to execute processing for executing a first random function H′ for the concatenated data x∥r to calculate H′(x∥r)=w and generate first random data w having a size not less than that of the concatenated data x∥r;
a fifth program code for causing the computer to execute processing for generating process target data s by calculating an exclusive OR between the concatenated data x∥r and the first random data w;
a sixth program code for causing the computer to execute processing for executing a second random function H for the process target data s to generate second random data H(s) having the same size as that of the first random data w;
a seventh program code for causing the computer to execute processing for generating padding data t by calculating an exclusive OR between the first random data w and the second random data H(s);
an eighth program code for causing the computer to execute processing for executing one of encryption processing and signature processing for the process target data s by the public key encryption scheme; and
a ninth program code for causing the computer to execute processing for concatenating the padding data t and one of encrypted data c and signed data c′ obtained by execution and outputting one of an obtained ciphertext c∥t and signature c′∥t.

10. An encryption/signature method used in an encryption/signature apparatus which can execute encryption processing and signature processing by a deterministic public key encryption scheme using a plurality of random functions, comprising:
inputting target data x of one of encryption processing and signature processing;
generating a random number r to be concatenated to the target data x;
concatenating the target data x and the random number r to obtain concatenated data x∥r;
executing a first random function H′ for the concatenated data x∥r to calculate H′(x∥r)=w and generate first random data w having a size not less than an input size of the public key encryption scheme;
executing a second random function G for the first random data w to generate second random data G(w) having a size not less than a size of the concatenated data x∥r;
generating padding data s by calculating an exclusive OR between the concatenated data x∥r and the second random data G(w);
executing one of encryption processing and signature processing for the first random data w by the public key encryption scheme; and
concatenating the padding data s and one of encrypted data c and signed data c′ obtained by execution and outputting one of an obtained ciphertext s∥c and signature s∥c′.

11. An encryption/signature apparatus which can execute encryption processing and signature processing by a deterministic public key encryption scheme using a plurality of random functions, comprising:
an input device which inputs target data x of one of encryption processing and signature processing;
a random number generator which generates a random number r to be concatenated to the target data x;
a first concatenation device which concatenates the target data x and the random number r to obtain concatenated data x∥r;
first random function operation means for executing a first random function H′ for the concatenated data x∥r to calculate H′(x∥r)=w and generate first random data w having a size not less than an input size of the public key encryption scheme;
second random function operation means for executing a second random function G for the first random data w to generate second random data G(w) having a size not less than a size of the concatenated data x∥r;
a padding data generation device which generates padding data s by calculating an exclusive OR between the concatenated data x∥r and the second random data G(w);
encryption/signature means for executing one of encryption processing and signature processing for the first random data w by the public key encryption scheme;
a second concatenation device which concatenates the padding data s and one of encrypted data c and signed data c′ obtained by execution; and
an output device which outputs one of an obtained ciphertext s∥c and signature s∥c′, which is obtained by the second concatenation device.

12. An encryption/signature apparatus which can execute encryption processing and signature processing by a deterministic public key encryption scheme using a plurality of random functions, comprising:
an input device which inputs target data x of one of encryption processing and signature processing;
a random number generator which generates a random number r to be concatenated to the target data x;
a first concatenation device which concatenates the target data x and the random number r to obtain concatenated data x∥r;
first random function operation device which executes a first random function H′ for the concatenated data x∥r to calculate H′(x∥r)=w and generate first random data w having a size not less than an input size of the public key encryption scheme;
second random function operation device which executes a second random function G for the first random data w to generate second random data G(w) having a size not less than a size of the concatenated data x∥r;
a padding data generation device which generates padding data s by calculating an exclusive OR between the concatenated data x∥r and the second random data G(w);
encryption/signature device which executes one of encryption processing and signature processing for the first random data w by the public key encryption scheme;
a second concatenation device which concatenates the padding data s and one of encrypted data c and signed data c′ obtained by execution; and
an output device which outputs one of an obtained ciphertext s∥c and signature s∥c′, which is obtained by the second concatenation device.

13. An encryption apparatus which encrypts received plaintext data x on the basis of the plaintext data x and a public key pk of a deterministic public key encryption scheme and outputs an obtained ciphertext, comprising:
a random number generator which generates a random number r to be concatenated to the plaintext data x;
a first concatenation device which concatenates the plaintext data x and the random number r to obtain concatenated data x∥r;
first random function operation means for executing a first random function H′ for the concatenated data x∥r to calculate H′(x∥r)=w and generate first random data w having a size not less than an input size of the public key encryption scheme;
second random function operation means for executing a second random function G for the first random data w to generate second random data G(w) having a size not less than a size of the concatenated data x∥r;
a padding data generation device which generates padding data s by calculating an exclusive OR between the concatenated data x∥r and the second random data G(w);
encryption means for encrypting the first random data w on the basis of the public key pk by the public key encryption scheme;
a second concatenation device which concatenates the padding data s and encrypted data c obtained by encryption processing to obtain a ciphertext s∥c; and
an output device which outputs the obtained ciphertext s∥c.

14. A decryption apparatus which, when a ciphertext s∥c is received, decrypts the ciphertext s∥c on the basis of the ciphertext c∥t and a private key sk of a deterministic public key encryption scheme and outputs obtained plaintext data x, the ciphertext s∥c being created from first random data w=H′(x∥r) obtained by executing a first random function H′ for concatenated data x∥r of the plaintext data x and a random number r, second random data G(w) obtained by executing a second random function G for the first random data w, padding data s obtained from an exclusive OR between the concatenated data x∥r and the second random data G(w), and encrypted data c obtained by encrypting the first random data w on the basis of a public key pk, and the ciphertext s∥c being obtained by concatenating the encrypted data c and the padding data s, comprising:
a first separation device which separates the ciphertext s∥c into the padding data s and the encrypted data c;
decryption means for decrypting the encrypted data c on the basis of the private key sk by the public key encryption scheme to obtain the first first random data w;
second random function operation means for executing the second random function G for the first first random data w to calculate the second random data G(w);
a concatenated data generation device which generates the concatenated data x∥r by calculating an exclusive OR between the second random data G(w) and the padding data t;
random data generation device which generates second first random data w′ by executing the first random function H′ for the concatenated data x∥r to calculate H′(x∥r)=w′;
determination means for determining whether the first first random data w and the second first random data w′ coincide with each other;
a second separation device which, when it is determined that the first first random data w and the second first random data w′ coincide with each other, separates the concatenated data x∥r to obtain the plaintext data x and the random number r; and
an output device which outputs the plaintext data x.

15. A signature apparatus which signs received document data x on the basis of the document data x and a private key sk of a deterministic public key encryption scheme and outputs an obtained signature, comprising:
a random number generator which generates a random number r to be concatenated to the document data x;
a first concatenation device which concatenates the document data x and the random number r to obtain concatenated data x∥r;
first random function operation means for executing a first random function H′ for the concatenated data x∥r to calculate H′(x∥r)=w and generate first random data w having a size not less than an input size of the public key encryption scheme;
second random function operation means for executing a second random function G for the first random data w to generate second random data G(w) having a size not less than a size of the concatenated data x∥r;
a padding data generation device which generates padding data s by calculating an exclusive OR between the concatenated data x∥r and the second random data G(w);
signature means for signing the first random data w on the basis of the private key sk by the public key encryption scheme;
a second concatenation device which concatenates the padding data s and signed data c′ obtained by signature processing to obtain a signature s∥c′; and
an output device which outputs the obtained signature s∥c′.

16. A signature verification apparatus which, when a signature s∥c′ is received, verifies authenticity of the signature s∥c′ on the basis of the signature s∥c′ and a public key pk of a deterministic public key encryption scheme, the signature s∥c′ being created from first random data w=H′(x∥r) obtained by executing a first random function H′ for concatenated data x∥r of the document data x and a random number r, second random data G(w) obtained by executing a second random function G for the first random data w, padding data s obtained from an exclusive OR between the concatenated data x∥r and the second random data G(w), and signed data c′ obtained by signing the first random data w on the basis of a private key sk by the public key encryption scheme, and the signature s∥c′ being obtained by concatenating the signed data c′ and the padding data s, comprising:
a first separation device which separates the signature s∥c′ into the padding data s and the signed data c′;
reconstruction means for reconstructing the signed data c′ on the basis of the public key pk by the public key encryption scheme to obtain the first first random data w;
second random function operation means for executing the second random function G for the first first random data w to calculate the second random data G(w);
a concatenated data generation device which generates the concatenated data x∥r by calculating an exclusive OR between the second random data G(w) and the padding data t;
second random data generation means for generating second first random data w′ by executing the first random function H′ for the concatenated data x∥r to calculate H′(x∥r)=w′;
determination means for determining whether the first random data w and the second first random data w′ coincide with each other; and
signature accepting means for, when it is determined that the first random data w and the second first random data w′ coincide with each other, accepting the signature c′∥t as an authentic signature.

17. A program which is stored on a computer-readable storage medium and used in a computer of an encryption/signature apparatus which can execute encryption processing and signature processing by a deterministic public key encryption scheme using a plurality of random functions, comprising:
a first program code for causing the computer to execute processing for inputting target data x of one of encryption processing and signature processing;
a second program code for causing the computer to execute processing for generating a random number r to be concatenated to the target data x;
a third program code for causing the computer to execute processing for concatenating the target data x and the random number r to obtain concatenated data x∥r;
a fourth program code for causing the computer to execute processing for executing a first random function H′ for the concatenated data x∥r to calculate H′(x∥r)=w and generate first random data w having a size not less than an input size of the public key encryption scheme;
a fifth program code for causing the computer to execute processing for executing a second random function G for the first random data w to generate second random data G(w) having a size not less than a size of the concatenated data x∥r;
a sixth program code for causing the computer to execute processing for generating padding data s by calculating an exclusive OR between the concatenated data x∥r and the second random data G(w);
a seventh program code for causing the computer to execute processing for executing one of encryption processing and signature processing for the first random data w by the public key encryption scheme; and
an eighth program code for causing the computer to execute processing for concatenating the padding data s and one of encrypted data c and signed data c′ obtained by execution and outputting one of an obtained ciphertext s∥c and signature s∥c′.
